(19) United States
(12) Patent Application Publication
(10) Pub. No.: US 2016/0308898 A1
(43) Pub. Date: Oct. 20, 2016

(54) SYSTEMS AND METHODS FOR TRACKING, ANALYZING AND MITIGATING SECURITY THREATS IN NETWORKS VIA A NETWORK TRAFFIC ANALYSIS PLATFORM

(71) Applicants: David James Wayne TEEPLE, Ottawa (CA); Christopher A. DODUNSKI, Ottawa (CA)

(72) Inventors: David James Wayne TEEPLE, Ottawa (CA); Christopher A. DODUNSKI, Ottawa (CA)

(73) Assignee: Phirelight Security Solutions Inc., Ottawa (CA)

(21) Appl. No.: 15/133,820

(22) Filed: Apr. 20, 2016

Related U.S. Application Data
(60) Provisional application No. 62/150,241, filed on Apr. 20, 2015.

(51) Int. Cl. H04L 29/06

(52) U.S. Cl. CPC H04L 63/1433; H04L 63/1441

(57) ABSTRACT

A network traffic analysis method for tracking, analyzing, and mitigating security threats in a network includes receiving information based on monitoring traffic at a plurality of layers at one or more monitors deployed in the network utilizing deep packet inspection; receiving information based on monitoring the traffic at an endpoint of the network; analyzing the monitored traffic from the endpoint and the one or more monitors to determine network infrastructure and cyber security posture of the network infrastructure; and providing visualizations based on the network infrastructure and the cyber security posture, continuously to track threats, watch lateral movement in the network of the traffic, and determine security event history in the network.

### CROSS-REFERENCE TO RELATED APPLICATION(S)

The present patent/application claims priority to U.S. Provisional Patent Application Ser. No. 62/150,241, filed Apr. 20, 2015, and entitled “SYSTEMS AND METHODS FOR TRACKING, ANALYZING AND MITIGATING SECURITY THREATS IN NETWORKS,” the contents of which are incorporated by reference.

### FIELD OF THE DISCLOSURE

The present disclosure generally relates to computer networking systems and methods. More particularly, the present disclosure relates to systems and methods for tracking, analyzing and mitigating security threats in networks.

### BACKGROUND OF THE DISCLOSURE

Every enterprise in every market vertical has a unique set of challenges when it comes to the implementation of information security infrastructure. As a small business or small Information Technology (IT) department in a medium-sized enterprise, it is often impractical to learn, monitor, and generally allocate the time necessary to ensure a network is protected every minute of every day. There are millions of cyber criminals, and tens of millions of cyber-attacks that plague the dependency on, and interaction with the Internet. Studies have shown human error plays a role in about 95% of cyber security incidents. The most common human error is opening infected attachments or going to infected web sites. About 23% of users open so-called phishing emails and about 11% of users open associated attachments. There is a general misconception that anti-virus software and a good firewall are all that is needed to provide the necessary protection. In most cases, the best anti-virus software money can buy protects about 15% to 20% of the malware that's currently out; 80% will evade it!

A firewall provides next to no protection as most hackers can break through firewalls in seconds. Security experts estimate that between 100,000 and 500,000 new malware variants are released each day. Most of these are called “zero-day” attacks. That means they have never been seen before and are extremely difficult to detect; in fact, anti-virus software and firewalls cannot detect them at all. Most attacks come in the form of email. A message, containing a coded attack is accidentally opened by an unsuspecting user, and it is game over; the malware installs itself and detonates. Others come via weaknesses in the firewall; these are what are termed “external attacks.” Internal attacks are sometimes caused by someone inside the network intentionally launching an attack, but may also be triggered accidentally by a user plugging in a compromised memory stick, surfing to a compromised web page, or simply launching an infected video; there are literally hundreds or even thousands of ways hackers and malware can get into the network. Whether internal or external the net result is generally crippling. In many cases, the breach may never be discovered. In others it is instantaneous and potentially devastating. Either way, a compromise (resolved or not)=damage and usually costs money.

Thus, disadvantageously, most advanced threats are virtually undetectable by anti-virus and security tools. To be considered successful, a security solution must be able to provide coverage that aligns with security requirements and unique business needs. This balancing act has many facets and, often times, conflicting requirements exist that result in a compromise or even inaction. There is a need for systems and methods for tracking, analyzing and mitigating security threats in networks.

### BRIEF SUMMARY OF THE DISCLOSURE

In an exemplary embodiment, a network traffic analysis method for tracking, analyzing, and mitigating security threats in a network includes receiving information based on monitoring traffic at a plurality of layers at one or more monitors deployed in the network utilizing deep packet inspection; receiving information based on monitoring the traffic at an endpoint of the network; analyzing the monitored traffic from the endpoint and the one or more monitors to determine network infrastructure and cyber security posture of the network infrastructure; and providing visualizations based on the network infrastructure and the cyber security posture, continuously to track threats, watch lateral movement in the network of the traffic, and determine security event history in the network. The visualizations can include a cyber kill chain analysis comprising a visual query of the network spanning multiple attributes, objects, and indicators of compromise (IOCs) representing analyzed monitored traffic determined as important to security and indicative of a compromise or breach of the network.

The visualizations can include Producer-Consumer Ratio (PCR) entropy scores for various nodes in the network, the PCR entropy scores track a ratio of producer to consumer data as a normalized index independent of data rate to provide an overall directionality of flow relative to a particular network node, and the network traffic analysis method further includes utilizing the PCR entropy scores to provide early detection of data exfiltration. The PCR entropy scores can be derived from Netflow information based on the monitoring the traffic. The one or more monitors can include one or more agents integrated into any of shared servers, Structured Query Language (SQL) servers, and mail servers to provide the information related to audit logs and event types. The one or more monitors can be deployed in selected areas of the network where deep packet analysis is needed, in various zones throughout the network. The monitoring the traffic can include utilization of Netflow, Data Fusion, and Deep Packet Inspection. The one or more monitors can include sensors plugged into a router port in the network. The network traffic analysis method can further include performing an active defense in the network based on the visualizations to one or more of quarantine, deny communication, restrict network ports, kill processes, throttle bandwidth, and revoke access.

In another exemplary embodiment, a network traffic analysis platform system for tracking, analyzing, and mitigating security threats in a network includes at least one sensor deployed in the network adapted to monitor traffic at a plurality of layers utilizing deep packet inspection; a monitor deployed at an endpoint in the network adapted to monitor traffic; and an analytics server communicatively coupled to the at least one sensor and the monitor, wherein the server is configured to receive information based on the monitored traffic, analyze the information to determine network infrastructure and cyber security posture of the network infrastructure, and provide visualizations based on the network infrastructure and the cyber security posture, continuously to track threats, watch lateral movement in the network of the traffic, and determine security event history in the network. The visualizations can include a cyber kill chain analysis comprising a visual query of the network spanning multiple attributes, objects, and indicators of compromise (IOCs) representing analyzed monitored traffic determined as important to security and indicative of a compromise or breach of the network.

The visualizations can include Producer-Consumer Ratio (PCR) entropy scores for various nodes in the network, the PCR entropy scores track a ratio of producer to consumer data as a normalized index independent of data rate to provide an overall directionality of flow relative to a particular network node, and wherein the server is further configured to utilize the PCR entropy scores to provide early detection of data exfiltration. The PCR entropy scores can be derived from Nedlow information based on the monitoring the traffic. The one or more monitors can include one or more agents integrated into any of shared servers, Structured Query Language (SQL) servers, and mail servers to provide the information related to audit logs and event types. The one or more monitors can be deployed in selected areas of the network where deep packet analysis is needed, in various zones throughout the network. The monitoring the traffic can include utilization of Nedlow, Data Fusion, and Deep Packet Inspection. The one or more monitors can include sensors plugged into a router port in the network. The server can be further configured to perform an active defense in the network based on the visualizations to one or more of quarantine, deny communication, restrict network ports, kill processes, throttle bandwidth, and revoke access.

In a further exemplary embodiment, an apparatus for tracking, analyzing, and mitigating security threats in a network includes a network interface communicatively coupled to the network; a processor communicatively coupled to the network interface; and memory storing instructions that, when executed, cause the processor to receive information based on monitoring traffic at a plurality of layers at one or more monitors deployed in the network utilizing deep packet inspection, receive information based on monitoring the traffic at an endpoint of the network, analyze the monitored traffic from the endpoint and the one or more monitors to determine network infrastructure and cyber security posture of the network infrastructure, and provide visualizations based on the network infrastructure and the cyber security posture, continuously to track threats, watch lateral movement in the network of the traffic, and determine security event history in the network. The visualizations can include a cyber kill chain analysis comprising a visual query of the network spanning multiple attributes, objects, and indicators of compromise (IOCs) representing analyzed monitored traffic determined as important to security and indicative of a compromise or breach of the network.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a network including an enterprise network connected to the Internet with a Network Traffic Analysis (NTA) platform connected to and/or in the enterprise network for monitoring therein;

FIG. 2 is a block diagram of a server which may be used in the network of FIG. 1, in other systems, or standalone;

FIG. 3 is a block diagram of a mobile device, which may be used in the network of FIG. 1 or the like;

FIG. 4 is a network diagram of the network of FIG. 1 illustrating additional details related to the NTA platform;

FIG. 5 is a flowchart illustrates an active defense process using the NTA platform of FIGS. 1 and 4 in the enterprise network;

FIGS. 6-19 are various screen shots illustrate exemplary embodiments of the GUI of the NTA platform 20 to describe how the cyber intelligence analytics server and the NTA platform provides intuitive, easy to follow visualization even for non-experts; and

FIGS. 20 -22 are various screen shots of services views for network visualization.

### DETAILED DESCRIPTION OF THE DISCLOSURE

Again, in various exemplary embodiments, the present disclosure relates to systems and methods for tracking, analyzing and mitigating security threats in networks. The systems and methods provide a visually intuitive cyber intelligence platform with end-to-end network visibility to highlight whatever threats are trying to enter the network and track down systems already infected. The systems and methods provide a context-aware cyber security NTA (Network Traffic Analysis) platform that provides situational awareness and remediation of cyber threats operating inside Small/Medium sized Businesses (SMB) and Enterprise networks. Using advanced network traffic analysis and machine learning, the cyber security platform allows users to track threats as they enter the network perimeter, watch lateral movement between endpoints, and develop a complete understanding of security event history. Beneficially, the cyber security platform reduces the time, money, and personnel to maintain an effective security posture while providing an unparalleled understanding of network infrastructure and cyber security posture. The cyber security platform provides scalable installation and zero-touch configurations offering a painless approach for acquiring full network visibility. Contextually linked cyber intelligence provides the full picture of what's really happening.

### Enterprise Network

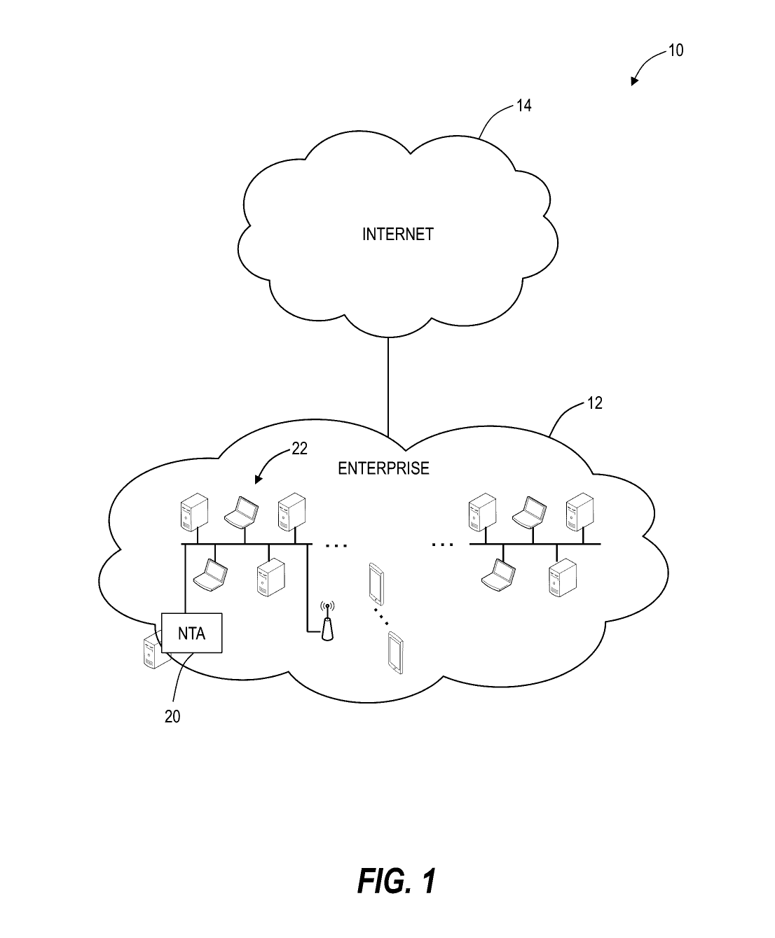

Referring to FIG. 1, in an exemplary embodiment, a network diagram illustrates a network 10 including an enterprise network 12 connected to the Internet 14 with a Network Traffic Analysis (NTA) platform 20 connected to and/or in the enterprise network 12 for monitoring therein. The enterprise network 12 can be any type of private network, with firewalls or the like demarcating access with the Internet 14. The enterprise network 12 can include various computing devices 22 connected therein such as, for example, desktop computers, laptop computers, tablets, ultra-books, mobile devices, servers, storage devices, printers, scanners, or any other computing platform with networking ability. The various user devices 22 can connect via wired and/or wireless access points in the enterprise network 12. Those of ordinary skill in the art will recognize various computing devices 22 with various connectivity techniques are contemplated herein in the enterprise network 12.

The NTA platform 20 is communicatively coupled to the enterprise network 12 and can be locally contained therein (e.g., within firewall boundaries) or remote (e.g., through a tunnel such as a Virtual Private Network (VPN) or the like). The NTA platform 20 provides full spectrum cyber intelligence and situational awareness and has the ability to look at deployments in the enterprise network 12 from multiple perspectives, whether being positioned exclusively for perimeter visibility (at or around the firewall), or for monitoring a server enclave (inside the enterprise network 12). However, in any deployment of situational awareness functionality, there is a tradeoff between depth of inspection and ease of deployment logistics of the inspection platform. Typically, deeper inspection of any situation requires the ability to see things from a perspective that is as close to the event source as possible. Quite often, deeper inspection also means being close to the endpoints to track their usage and behaviors. In the enterprise network 12, that means being close to all the data producers and/or data consumers. Servers, transport nodes and endpoints, i.e., the computing devices 22, all possess the characteristics of either a data producer or a data consumer to some degree and in a ratio indicative of their function or purpose.

### Exemplary Server

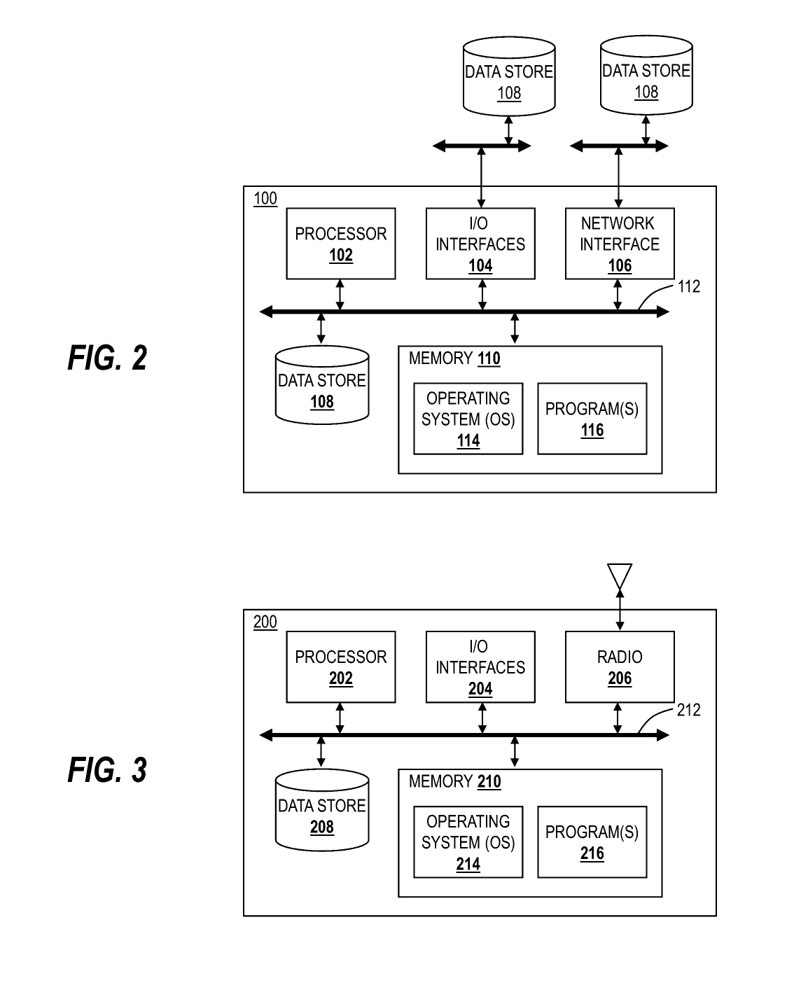

Referring to FIG. 2, in an exemplary embodiment, a block diagram illustrates a server 100 which may be used in the network 10, in other systems, or standalone. Any of the NTA platform 20 and the computing devices 22 may be formed through one or more servers 100. The server 100 may be a digital computer that, in terms of hardware architecture, generally includes a processor 102, input/output (I/O) interfaces 104, a network interface 106, a data store 108, and memory 110. It should be appreciated by those of ordinary skill in the art that FIG. 2 depicts the server 100 in an oversimplified manner, and a practical embodiment may include additional components and suitably configured processing logic to support known or conventional operating features that are not described in detail herein. The components (102, 104, 106, 108, and 110) are communicatively coupled via a local interface 112. The local interface 112 may be, for example but not limited to, one or more buses or other wired or wireless connections, as is known in the art. The local interface 112 may have additional elements, which are omitted for simplicity, such as controllers, buffers (caches), drivers, repeaters, and receivers, among many others, to enable communications. Further, the local interface 112 may include address, control, and/or data connections to enable appropriate communications among the aforementioned components.

The processor 102 is a hardware device for executing software instructions. The processor 102 may be any custom made or commercially available processor, a central processing unit (CPU), an auxiliary processor among several processors associated with the server 100, a semiconductor-based microprocessor (in the form of a microchip or chip set), or generally any device for executing software instructions. When the server 100 is in operation, the processor 102 is configured to execute software stored within the memory 110, to communicate data to and from the memory 110, and to generally control operations of the server 100 pursuant to the software instructions. The I/O interfaces 104 may be used to receive user input from and/or for providing system output to one or more devices or components. User input may be provided via, for example, a keyboard, touch pad, and/or a mouse. System output may be provided via a display device and a printer (not shown). I/O interfaces 104 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 106 may be used to enable the server 100 to communicate over a network, such as the Internet 14, the enterprise network 12, and the like, etc. The network interface 106 may include, for example, an Ethernet card or adapter (e.g., 10BaseT, Fast Ethernet, Gigabit Ethernet, 10GbE) or a wireless local area network (WLAN) card or adapter (e.g., 802.11a/b/g/n). The network interface 106 may include address, control, and/or data connections to enable appropriate communications on the network. A data store 108 may be used to store data. The data store 108 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 108 may incorporate electronic, magnetic, optical, and/or other types of storage media. In one example, the data store 108 may be located internal to the server 100 such as, for example, an internal hard drive connected to the local interface 112 in the server 100. Additionally, in another embodiment, the data store 108 may be located external to the server 100 such as, for example, an external hard drive connected to the I/O interfaces 104 (e.g., SCSI or USB connection). In a further embodiment, the data store 108 may be connected to the server 100 through a network, such as, for example, a network attached file server.

The memory 110 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 110 may incorporate electronic, magnetic, optical, and/or other types of storage media. Note that the memory 110 may have a distributed architecture, where various components are situated remotely from one another, but can be accessed by the processor 102. The software in memory 110 may include one or more software programs, each of which includes an ordered listing of executable instructions for implementing logical functions. The software in the memory 110 includes a suitable operating system (O/S) 114 and one or more programs 116. The operating system 114 essentially controls the execution of other computer programs, such as the one or more programs 116, and provides scheduling, input-output control, file and data management, memory management, and communication control and related services. The one or more programs 116 may be configured to implement the various processes, algorithms, methods, techniques, etc. described herein.

### Exemplary Mobile Device

Referring to FIG. 3, in an exemplary embodiment, a block diagram illustrates a mobile device 200, which may be used in the network 10 or the like. The mobile device 200 can be a digital device that, in terms of hardware architecture, generally includes a processor 202, input/output (I/O) interfaces 204, a radio 206, a data store 208, and memory 210. It should be appreciated by those of ordinary skill in the art that FIG. 3 depicts the mobile device 200 in an oversimplified manner, and a practical embodiment may include additional components and suitably configured processing logic to support known or conventional operating features that are not described in detail herein. The components (202, 204, 206, 208, and 202) are communicatively coupled via a local interface 212. The local interface 212 can be, for example but not limited to, one or more buses or other wired or wireless connections, as is known in the art. The local interface 212 can have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 can be any custom made or commercially available processor, a central processing unit (CPU), an auxiliary processor among several processors associated with the mobile device 200, a semiconductor-based microprocessor (in the form of a microchip or chip set), or generally any device for executing software instructions. When the mobile device 200 is in operation, the processor 202 is configured to execute software stored within the memory 210, to communicate data to and from the memory 210, and to generally control operations of the mobile device 200 pursuant to the software instructions. In an exemplary embodiment, the processor 202 may include an optimized mobile processor such as optimized for power consumption and mobile applications. The I/O interfaces 204 can be used to receive user input from and/or for providing system output. User input can be provided via, for example, a keypad, a touch screen, a scroll ball, a scroll bar, buttons, barcode scanner, and the like. System output can be provided via a display device such as a liquid crystal display (LCD), touch screen, and the like. The I/O interfaces 204 can also include, for example, a serial port, a parallel port, a small computer system interface (SCSI), an infrared (IR) interface, a radio frequency (RF) interface, a universal serial bus (USB) interface, and the like. The I/O interfaces 204 can include a graphical user interface (GUI) that enables a user to interact with the mobile device 200.

The radio 206 enables wireless communication to an external access device or network. Any number of suitable wireless data communication protocols, techniques, or methodologies can be supported by the radio 206, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 210 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 210 may incorporate electronic, magnetic, optical, and/or other types of storage media. Note that the memory 210 may have a distributed architecture, where various components are situated remotely from one another, but can be accessed by the processor 202. The software in memory 210 can include one or more software programs, each of which includes an ordered listing of executable instructions for implementing logical functions. In the example of FIG. 3, the software in the memory 210 includes a suitable operating system (O/S) 214 and programs 216. The operating system 214 essentially controls the execution of other computer programs and provides scheduling, input-output control, file and data management, memory management, and communication control and related services. The programs 216 may include various applications, add-ons, etc. configured to provide end user functionality with the mobile device 200. For example, exemplary programs 216 may include, but not limited to, a web browser, social networking applications, streaming media applications, games, mapping and location applications, electronic mail applications, financial applications, and the like. In a typical example, the end user typically uses one or more of the programs 216 along with a network such as the enterprise network 12.

### NTA Platform

The NTA platform 20 provides situational awareness and cyber security functionality, and offers one or more of the following features:

A blend of global network visibility and deep packet forensics;

Intuitive and visual depiction of information that allows easy review;

Information exchange between security ecosystem components;

Simplified deployment logistics (i.e. depth and breadth of deployment is modular);

Ease of management with drill-down capability for additional forensic capability;

Scalable and distributed architecture suitable for deployment of any size; and

Actionable intelligence and analytics provide answers to the cyber threat questions in real-time.

The NTA platform 20 provides cyber intelligence/situational awareness that allows a network operator, security personnel, Information Technology (IT) personnel, etc. to detect and remediate cyber kill chain events as early as possible, thus reducing or eliminating their effect on the network. The system efficiently exchanges information between functional areas of monitoring and analytics, and thus vastly improves the effectiveness of the deployment.

The term “cyber kill chain” is used by those of ordinary skill in the art of security to described the different stages of cyber-attacks. The following is a brief description of seven stages if the cyber kill chain.

Step 1: Reconnaissance. The attacker gathers information on the target before the actual attack starts. The attacker can do it by looking for publicly available information on the Internet 14.

Step 2: Weaponization. The attacker uses an exploit and creates a malicious payload to send to the victim. This step happens at the attacker side, without contact with the victim.

Step 3: Delivery. The attacker sends the malicious payload to the victim by email or other means, which represents one of many intrusion techniques the attacker can use.

Step 4: Exploitation. The actual execution of the exploit, which is, again, relevant only when the attacker uses an exploit.

Step 5: Installation. Installing malware on the infected computing device 22 in the enterprise 12 is relevant only if the attacker used malware as part of the attack, and even when there is malware involved, the installation is a point in time within a much more elaborate attack process that takes months to operate.

Step 6: Command and control. The attacker creates a command and control channel in order to continue to operate his internal assets remotely. This step is relatively generic and relevant throughout the attack, not only when malware is installed.

Step 7: Action on objectives. The attacker performs the steps to achieve his actual goals inside the enterprise network 12. This is the elaborate active attack process that takes months, and thousands of small steps, in order to achieve.

In fact, steps 1 through 6 of the Chain relates solely to intrusion, which is, as we know from recent attacks, only a very small part of a targeted attack. Along these same lines, the Chain is disproportionate on an attack time scale: Steps 1 through 6 take relatively little time, whereas step 7 can take months. Further, it is worth considering that steps 1, 2, and 3 are not relevant from an operational point of view. These are just the documentation of steps an attacker may take behind the scenes, not something that security professionals can directly address or influence.

The NTA platform 20 gains situational awareness by monitoring all aspects of activity in the enterprise network 12 including Nedlow (Layer 3 and 4), Deep Packet Inspection (Layer 2 through Layer 7), endpoint activity logging, critical asset monitoring, file integrity monitoring, payload de-obfuscation, tunneling detection, application and protocol classification, kill chain tracking, and the like. Nedlow is a feature on Cisco routers that provides the ability to collect Internet Protocol (IP) network traffic as it enters or exits an interface. Deep Packet Inspection (DPI, also called complete packet inspection and Information eXtraction or IX) is a form of computer network packet filtering that examines the data part (and possibly also the header) of a packet as it passes an inspection point, i.e., the NTA platform 20, searching for protocol non-compliance, viruses, spam, intrusions, or defined criteria to decide whether the packet may pass or if it needs to be routed to a different destination, or, for the purpose of collecting statistical information. There are multiple headers for IP packets; network equipment only needs to use the first of these (the IP header) for normal operation, but use of the second header (Transmission Control Protocol (TCP), User Datagram Protocol (UDP), etc.) is normally considered to be shallow packet inspection (usually called Stateful Packet Inspection) despite this definition.

In addition, the NTA platform 20 learns what is normal and what is abnormal in the enterprise network 12 using a combination of blacklist/whitelist checks, regular expression validation, fuzzy analysis of payload, threshold crossing detection, single-touch impact assessments, behavioral validation of user actions, automated malware sandboxing, temporal node entropy analytics, and the like.

Tradeoffs exist between various analytics and inspection techniques (e.g., Deep Packet Analytics, Netflow analytics etc.). As all analytics methodologies have unique benefits, the NTA platform 20 envisions that multiple techniques be used in the correct balance to provide the best results. As each network is unique in architecture, concerns (e.g. the type of threat being analyzed) and/or requirements, the ratio of utilization of each technique will also be unique to the environment. The present disclosure envisions use of a plurality of the following analytical methods with the NTA platform 20 in a balanced approach:

Netflow-based Analytics: Netflow-based analytics are typically deployed for global visibility of the enterprise network 12 as it provides a higher-level summary awareness of network environments. This technique involves multiple sources (such as routers and flow meters) feeding Netflow records to a ‘store and forward’ function that may normalize the received data (for example, translate v9 to the most commonly received format, or v5) and forward to an analytics function. Normalization ensures that a common data is available for further analysis. Analytics is performed on the normalized data set, and involves calculating producer-consumer ratios (PCR), clustering nodes by perceived function, and applying entropy analytics to find outliers and trends within the clusters. Netflow analytics improves with the volume of data being analyzed. For smaller data volumes, the statistical sampling is insufficient to provide accurate outlier analysis. Netflow records do not include the payload information but merely header information including but not limited to some of the following: Source IP address, Destination IP address, Source Port, Destination Port, Protocol, TCP Flag information, Time Info, Byte Info, Packet Info, and Internet Control Message Protocol (ICMP) Info. Essentially, Netflow focuses on Layer-3 (network layer) and Layer-4 (transport layer) of the 7-layer OSI stack. As Netflow generation and delivery does impose additional processing load on devices such as routers, sampled data may be used to alleviate the processing load. However, depending on the anomaly type, detection rates can fall significantly when using sampling rates as low as 1:10. As such, if accurate anomaly detection is desired, external flow meters may be considered to reduce or eliminate the need for flow sampling. The external flow meters can be deployed in the enterprise network 12 and communicate to the NTA platform 20.

Data Fusion Traffic Analytics: This technique augments Netflow and DPI information. In this technique, data sets containing network traffic header information (received from Netflow or DPI level monitoring) are assessed against known cyber threats (IP, port for traffic analysis) using adaptive contextual processing. Cyber threat intelligence can be generated from flow based analytics functions (e.g., dark space monitoring using Netflow) or it can be consumed as a service from threat intelligence sources (these threat intelligence sources can be information feeds that are commercial, open source or government-based). Data fusion analytics can thus be implemented as a valuable augmentation layer dynamically providing context to the Netflow and Deep Packet analytics, to ultimately increase the certainty of anomaly detection. In embodiments, the use of Data fusion analytics stage allows for quick identification of what is already known to be unwanted network communications so that outliers can have an additional weighting applied to their inherent risk scores. Data fusion analytics is relatively independent of the deployment size, as it is essentially a threat intelligence service. The above-noted threat intelligence sources includes examples such as Virus Total (a website which checks for viruses that the user's own antivirus may have missed, or to verify against any false positives) and Team Cymru (which provides services related to security), and provides the NTA platform 20 with information about known threat actors, known malware, known artifacts, etc. This enables the NTA platform 20 and/or the network operator to spot security threats.

Deep Packet Analytics: Functional deep packet inspection (DPI) typically requires enclave-level visibility (i.e., a distributed presence deeper in the enterprise network 12) in order to deliver user-level and application-level attribution and to provide context to observed events. An enclave represents a logical zone or area of awareness, which may be associated either with a functional area in the enterprise network 12 (e.g. the accounting department of the enterprise), or a geographic area in the enterprise network 12 (e.g. regional office XYZ, or 5th floor of the R&D building). Primarily, DPI functionality is for the purposes of inspecting the payload for malicious artifacts, application tracking, message analysis, behavioral, dynamic and static payload analysis, etc. DPI techniques focus on Layer-2 to Layer-7 of the 7-layer stack.

The table below (Table 1) shows the relative anomaly and detection coverage that may be obtained by the various analytics techniques noted above.

TABLE 1

| Anomaly/Detection Type | Netflow | Data Fusion | Deep Packet |
|---|---|---|---|
| Distributed Denial of | Excellent | Marginal | Good |
| Service (DDOS) | | | |
| Reconnaisance | Excellent | Marginal | Good |
| Worm Propagation | Excellent | N/A | Good |
| Lateral Movement | Excellent | N/A | Excellent |
| Tunnel Detection | Poor | N/A | Excellent |
| Protocol Detection | Marginal | N/A | Excellent |
| Application Classification | Marginal | N/A | Excellent |
| Producer-Consumer Ratio | Excellent | N/A | Good |
| Clustering | | | |
| Malicious Payload | N/A | Excellent | Excellent |
| Suspicious Payload | N/A | Good | Excellent |
| Network Inventory | Good | N/A | Excellent |
| User Attribution | Poor | N/A | Excellent |
| User Behavior | Poor | N/A | Excellent |
| Data Exfiltration | Excellent | N/A | Excellent |
| Command & Control | Good | Good | Excellent |

The table below (Table 2) shows the relative logistics ease for deployment for different analytical techniques for different sizes of networks.

TABLE 2

| Network Size | Netflow | Data Fusion | Deep Packet |
|---|---|---|---|
| Small (<10 zones) | Marginal | Excellent | Excellent |
| Medium (<100 zones) | Good | Excellent | Excellent |
| Large (>100 zones) | Excellent | Excellent | Good |

The table below (Table 2) shows the relative logistics ease for deployment for different analytical techniques for different sizes of networks.

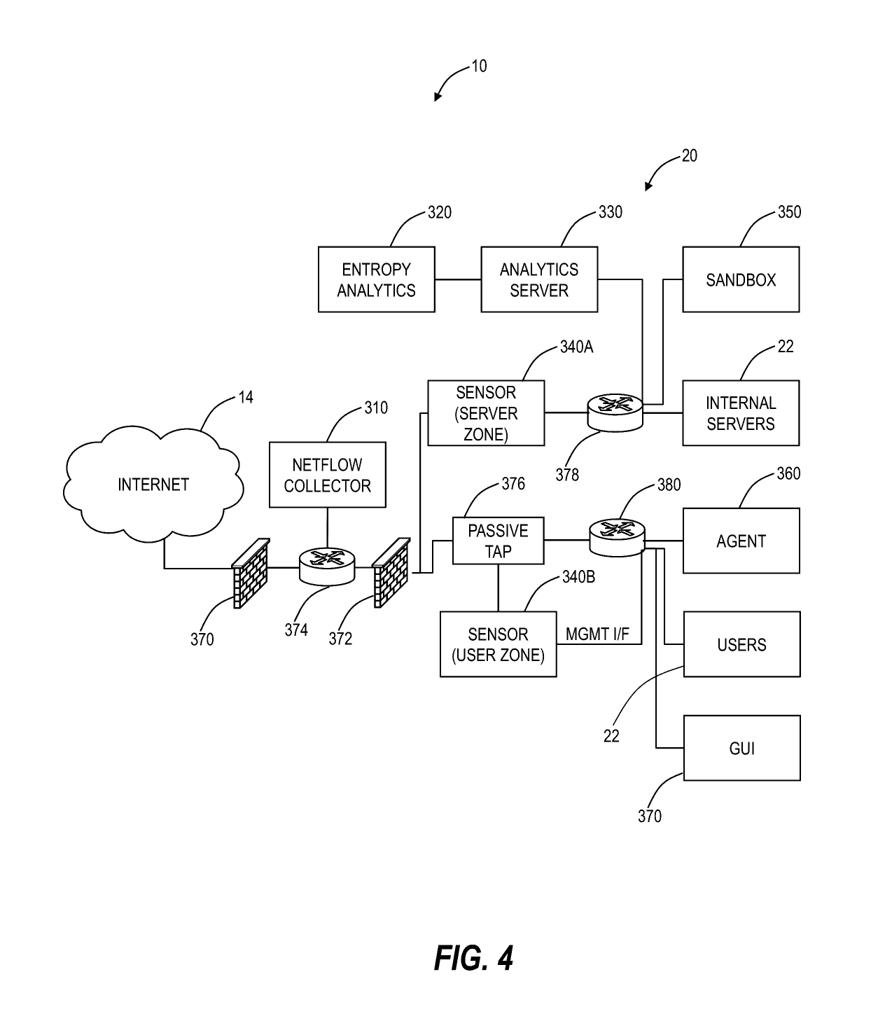

Referring to FIG. 4, in an exemplary embodiment, a network diagram illustrates the network 10 illustrating additional details related to the NTA platform 20. Specifically, the NTA platform 20 includes various devices distributed throughout the enterprise network 12, such as a Nedlow collector 310, an entropy analytics server 320, a cyber intelligence analytics server 330, sensors 340A, 340B, a sandbox 350, an agent 360, and a Graphical User Interface (GUI) 370. The enterprise network 12 can be connected to the Internet 14 via firewalls 370, 372 and a router 374. The router 374 routes data between the Internet 14 and the enterprise 12, through the firewalls 370, 372. The sensors 340a, 340b can be connected to the router 374, through the firewall 372. The sensor 340B can be coupled to a passive tap 376. The enterprise network 12 can include routers 378, 380 between the firewall 372 and various computing devices 22 as well as the entropy analytics server 320, the analytics server 330, the sandbox 350, the agent 360, and the GUI 370.

The Nedlow collector 310 is communicatively coupled to the router 374 and is configured to ingest Nedlow records from globally deployed router instances, such as through the router 374. These records are normalized, de-duplicated, and later fed through a Producer-Consumer Ratio (PCR) entropy analytics server 320 for machine learning analysis.

The PCR entropy analytics server 320 calculates the PCR entropy scores for each node in the network, clusters the information and produces alerts to a cyber-intelligence analytics server 330 when outliers are detected (i.e., abrupt shifts in PCR roles within a cluster). This type of shift PCR is typically indicative of data exfiltration behavior. The PCR entropy analytics server 320 may be installed on premise in exemplary embodiments. Implementation of the various functionalities described herein may be done in a single computing device or in a plurality of computing devices. For example, the PCR entropy analytics functionality may be implemented in a single server or across multiple servers.

A cyber intelligence analytics server 330 receives information from the entropy analytics server cluster and any sensors that provide deep packet payload inspection. The cyber intelligence analytics server 330 also provides web portal visualization and threat intelligence/data fusion augmentation for the gathered information.

The sensors 340a, 340b are deployed in areas in the enterprise network 12 where deep packet payload analysis is desirable (for example, in critical or sensitive locations). The sensors 340a, 340b can be deployed inline (e.g., as shown with the sensor 140a) or passively (e.g., as shown with the sensor 140b and the passive tap 376). Note, the sensor 140a could be passive and the sensor 140b could be inline. Also, the enterprise network 12 can have one or multiple sensors 140a, 140b. The sensors 140a, 140b function as traffic payload inspectors, event collectors and active defense launch points if automated remediation of detected threats is desirable. Zone sensors, such as the sensors 140a, 140b, may in exemplary embodiments, incorporate DPI functionality and data fusion functionality that can be leveraged to identify known threat actors, malicious messages and malicious payloads. The Data fusion functionality of such a zone sensor can provide information such as known Uniform Resource Locator (URL), Uniform Resource Identifier (URI), File hash, Email data, Domain Name System (DNS), etc. for addition to the overall “blacklist” picture.

The sandbox 150 is positioned in this deployment as part of the overall payload inspection capability. As files and payloads are extracted from the network traffic, they can be fed through a cascading series of analysis that looks for malicious artifacts or suspicious objects embedded in the payload.

With respect to the PCR entropy analytics server 120, Producer-Consumer Ratio (PCR) tracks the ratio of producer data levels to consumer data levels and is a normalized index that is independent of data rate and provides an overall directionality of flow relative to a network node. It is defined as the ratio of (Source Payload Byte Count—Destination Payload Byte Count) and (Source Payload Byte Count—Destination Payload Byte Count). It ranges from −1.0 for a Consumer to a +1.0 for a Producer.

For a time series of data, entropy is the difference between expected results and actual results when analyzing the time series of data. For Producer-Consumer Ratio (PCR) measurements, a substantial shift in PCR can indicate a shift in role either from producer to consumer or vice versa.

As such, PCR entropy measurements can provide early detection of data exfiltration where content based analysis either fails or is not present. Entropy analysis of PCR can be performed using traditional Netflow v5 levels of information analysis. In addition, entropy analysis of PCR entails that node classification frameworks are not required as we are dealing with normalized indices and their respective shift in trends. Abnormal lateral movement and data exfiltration can be identified through the detection of a sudden or substantive shift in PCR (i.e. the entropy of the PCR increases). Coupled with deep packet analysis, the context and potential impact of identified data exfiltration can be easily produced.

With the foregoing NTA platform 20, threats can be tracked as they enter the enterprise network 12 perimeter as well as monitoring lateral movement between endpoints to develop a complete understanding of security event history. The NAT platform 20 is built on the philosophy of ‘watch’, ‘learn’, ‘react’. That is, know the enterprise network 12, know the associated threats, and take control.

The agent 360 can be a computing device 22 or the like with an application or web browser adapted to access the NTA platform 20. The GUI 370, while illustrated as a separate element from the agent 360, can operate on the agent 360 or some other computing device 22. It is through the agent 360 and/or the GUI 370 that network operators, security personnel, IT personnel, etc. use to access and operate the NTA platform 20. The GUI 370 provide network traffic analytics, temporal node entropy analytics, dynamic granular control, visual cyber kill chain analysis, cyber intelligence, multi-vector defense, real-time detection, content inspection, and the like. The NTA platform 20 contemplates plug-and-play installation, a scalable architecture, third-party integration through Application Programming Interfaces (APIs), and the like. The NTA platform 20 contemplates use with or without the agent 360. Without the agent 360, the GUI 370 can be utilized with any computing device 22. The GUI 370 enables contextually linked cyber intelligence providing a full picture of the enterprise network 12.

In addition to the sensors 340, the agents 360 can be Critical Asset Monitoring Agents (CAMAs) that can be integrated into critical assets like shared servers such as Microsoft SharePoint, Structured Query Language (SQL) servers, mail servers such as Microsoft Exchange, and the like. The agents 360 can gain deeper understanding of audit logs and event types with the need for bloated or intrusive software.

Features and benefits of the NTA platform 20 include machine learning, cyber kill chain analysis, real-time detection, dynamic granular control, a flexible and scalable architecture, intuitive visualization, a multi-vector defense, advanced multi-engine scanning, application awareness, endpoint remediation, and a threat feed.

For machine learning, agentless implementations are able to detect endpoint malicious activity regardless of the end-point operating system or device type. For cyber kill chain analysis, there is an ability to define custom series of suspicious cyber events and use visual queries to find out if other endpoints in your network have been affected within seconds, so you can take immediate remediation action. For real-time detection, there is no need to continuously monitor the network 12, rather, the NTA platform 20 can provide real-time, customized alerts and reporting. For dynamic granular control, to counteract threats, the NTA platform 20 integrates seamlessly with technology partners to provide the lightest touch possible with the single click of a button.

For the flexible and scalable architecture, the NTA platform 20 is scalable from SMB to large complex enterprises. For the intuitive visualization, the GUI 370 is adapted to present information in a logical and easy to follow manner. For multi-vector defense, cyber defense options range from automated, to semi-automated, to manual. Entirely configurable to your tolerance or operational ability. Stopping threats is easy and automated, the NTA platform 20 can instantly and permanently quarantine threats and malicious behavior. Additionally, the defense can be a native Active Defense with the NTA platform 20 or an integrated third party solution.

For the advanced multi-engine scanning, the NTA platform 20 can quickly scan files with dozens of antimalware engines for known and unknown threats, improving the malware detection rate, and speeding up throughput. The NTA platform 20 can utilize advanced threat protection and analytics to prevent undetected zero-day and targeted attacks. For application awareness, the NTA platform 20 knows if an application is being used to compromise information systems or send corporate data out of the enterprise network 12 to those with malicious intent.

For endpoint remediation, the NTA platform 20 takes the sting out of Advanced Persistent Threats by augmenting with Endpoint Remediation. The Endpoint Remediation incorporates proactive mitigation technology to ensure that zero-day attacks can be rapidly detected and removed from endpoints. For the threat feed, the NTA platform can provide continuous updates to software and threat intelligence.

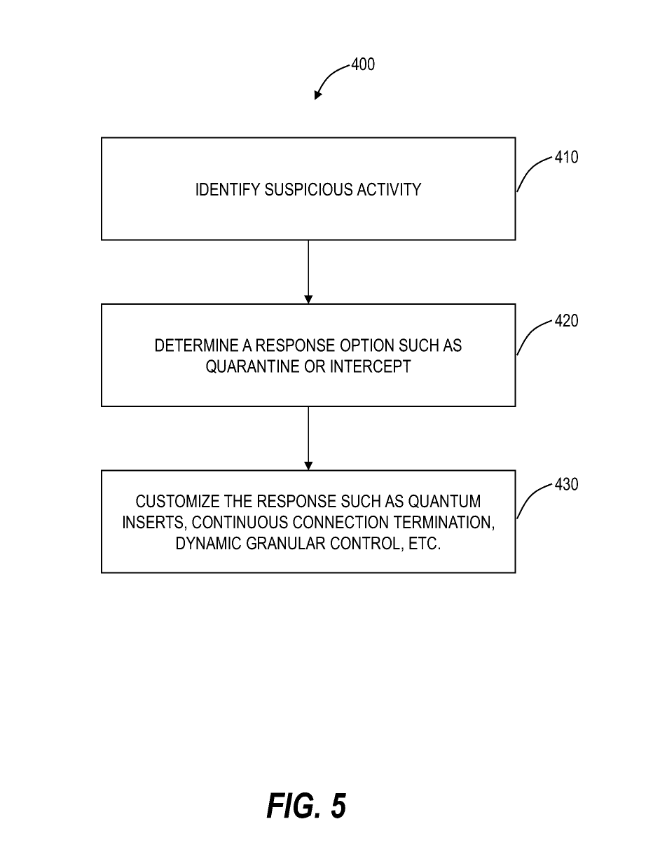

Referring to FIG. 5, in an exemplary embodiment, a flowchart illustrates an active defense process 400 using the NTA platform 20 in the enterprise network 12. One aspect of the NTA platform 20 includes an active defense which provides simplified remediation and blocking capabilities. Without impacting operation of the enterprise network 12, network operators are given full control to filter traffic and adjust tolerance levels. The network operators can visually and intuitively select a level of aggressiveness applied to custom rules and restrictions.

The active defense process 400 includes identifying suspicious activity (step 410), determining a response option such as quarantine or intercept (step 420), and customizing the response such as quantum inserts, continuous connection termination, dynamic granular control, etc. (step 430). The active defense process 400 provides simplified remediation and blocking capabilities. With a single button clearly labeled in the GUI 370's intuitive interface, users can block whatever is threatening the enterprise network 12, whenever they want.

The active defense process 400 uses the same underlying threat intelligence and network traffic analysis software and equipment as the NTA platform 20, applying it to a dedicated blocking function. Without impacting business operations, an operator of the enterprise network 20 is given full control to filter traffic and adjust tolerance levels. Users can easily and intuitively select the level of aggressiveness applied to their custom rules and restrictions. Taking control is about the remediation of a problem. Instantaneous and 100% effective. However, in an ideal world, the lightest touch is always best. Various aspects of the active defense process 400 can include Quarantine users, Deny communications, Restrict network ports, Kill processes, Throttle bandwidth, Revoke access, and Other custom mitigation capabilities.

In an exemplary embodiment, the NTA platform 20 can be a highly sophisticated threat detection, prevention and alerting system that combines advanced behavioral analytics with real-time threat monitoring. The sensors 340 can be delivered in a single box (computer) as one of the sensors 340. Installation is quick and easy. The sensor 340 can plug into an internet port on a router (or internet facing device). The sensor 340 was developed to provide world-class security monitoring and alerting services for the small business. The service provides the equivalent of a full-time, cyber security department operating for a business 24 hours a day, 7 days a week, 365 days a year that is staffed by a team of highly skilled cybersecurity professionals utilizing the world's most efficient and advanced tools.

The services offered by the sensor 340 are more than security monitoring. The services can include protection from malicious email attacks and hostile websites, and the option to continually protect files from the dreaded and insidious list of ransomware attacks—those that lock computers and force a ransom (often in bitcoins) to have the system restored.

The sensors 340 provide full-spectrum security protection and awareness of the following: Email protection against spear-phishing, Email cleansing of malicious content, Malware detection & prevention (including ransomware like Cryptolocker), Backdoors, Botnets, Command & Control Traffic, Viruses, Trojans, Data Exfiltration Attempts, and Other Advanced Persistent Threats (APT' s). All collected data can be compared in the NTA platform 20 against numerous behavioral analysis and threat intelligence databases and activity baselines to identify suspicious or malicious processes, network connections, and traffic patterns for evidence of compromise.

With the sensors 340, email cleansing (spear-phishing prevention) can be through a simple change to DNS settings (which the NTA platform 20 can assist) and the service will intercept and cleanse email of malicious content and spear-phishing attacks by using Anti-Exploit Technology. Network traffic inspect can occur through the sensors 340 deployed inside the network 12, watching Internet communications. The purpose of the inspection is to detect cyber-attacks and potential breaches in the network 12. For ransomware prevention software installation, users running Windows systems are provided with specialized software to detect and stop Cryptolocker from encrypting critical files and holding hostage for money.

### GUI Implementation

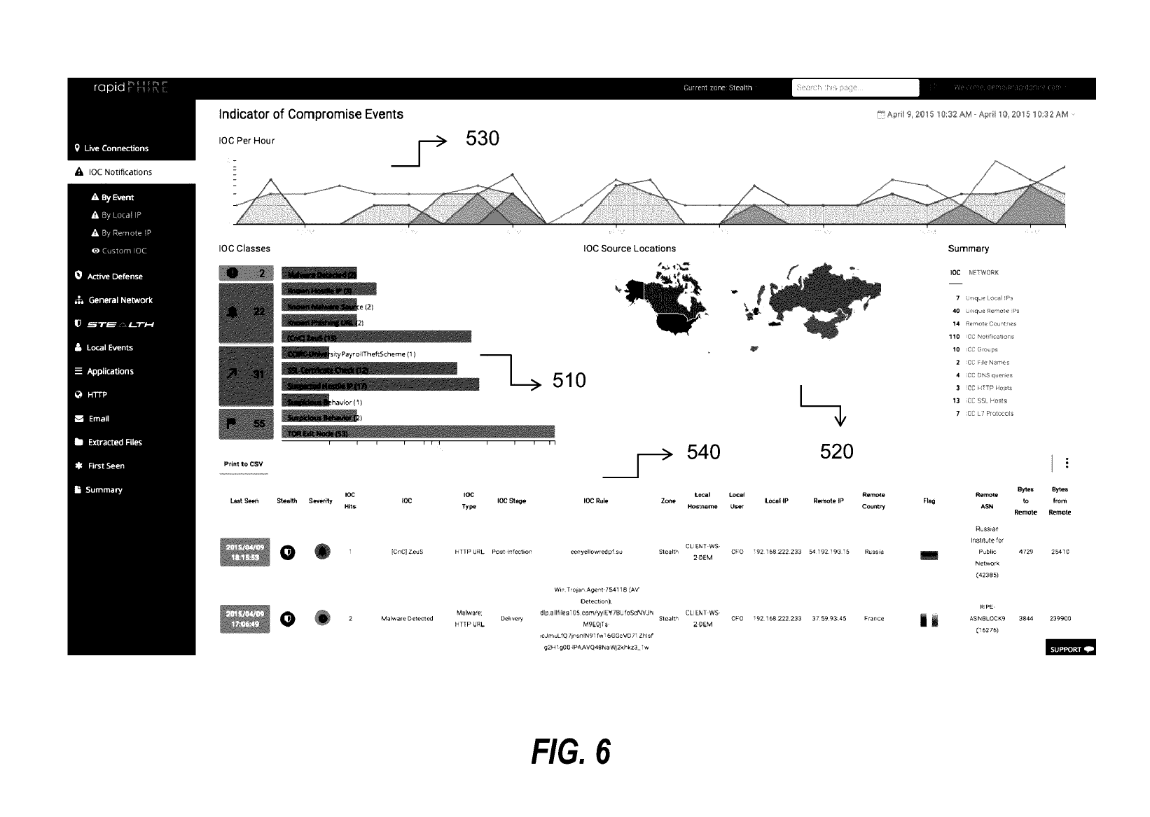

Referring to FIGS. 6-19, in various exemplary embodiments, various screen shots illustrate exemplary embodiments of the GUI 370 to describe how the cyber intelligence analytics server 130 and the NTA platform 20 provides intuitive, easy to follow visualization even for non-experts. As cyber intelligence is contextually linked, it provides an operator with a full picture of what is really happening with his/her network. Such visualization capability may also be provided via a Web-based GUI at a user terminal.

FIG. 6 illustrates an exemplary dashboard that displays and classifies indicators of compromise (IOC) detected within a time period (for example, the dashboard could be a 24-hour IOC Dashboard for IOC detected with the previous 24 hours) within a zone (note the phrase ‘Current Zone: Stealth’ in the top bar of FIG. 6) of the network 12. An IOC represents observed, derived or analyzed information that the system and method of the present disclosure has determined as being of importance to a security-conscious network operator. In other words, it is one piece of evidence that may show a compromise or breach of a system. These IOCs can be derived from threat intelligence (e.g. a piece of known malware), be rule based (e.g. a user or a device has connected to a known malicious IP host at 123.123.123.222) or can be behavior indicators (e.g. system XYZ is doing a strange activity such as port scanning or it has shifted its PCR role from Consumer to Producer).

Zones represent a region of visibility for the network operator. Division of the network 12 of interest into zones allows for segmentation of data, which provides better scalability and ease of use for the customer. Zones for the network 12 may be chosen by the network operator, and may be functional or geographical in nature. The dashboard may be configured to also show similar information for other zones of the network. A pull down menu is provided to allow a user to navigate quickly between different zones without reverting back to the start of the workflow. A user can thus retain the visibility framework, but yet shift the underlying data to a different data set by selecting a new zone.

In embodiments, the dashboard may also be updated in real-time as new information comes into the system. In embodiments, all objects of the dashboard may be clicked on or otherwise selected/accessed to display additional information or trigger options for action or analysis. In the embodiment of FIG. 6, the dashboard shows the classes of IOC 510, source locations 520, as well as the trends for the various IOC classes over time 530. Summary information may also be provided. Some details of a few of the most recent IOCs may also be displayed, and additional information may be obtained by clicking further. Exemplarily, these details are provided in a tabular format 540 and can be exported into a comma separated value file (using the Print to CSV option of FIG. 6) for further analysis using other spreadsheet products.

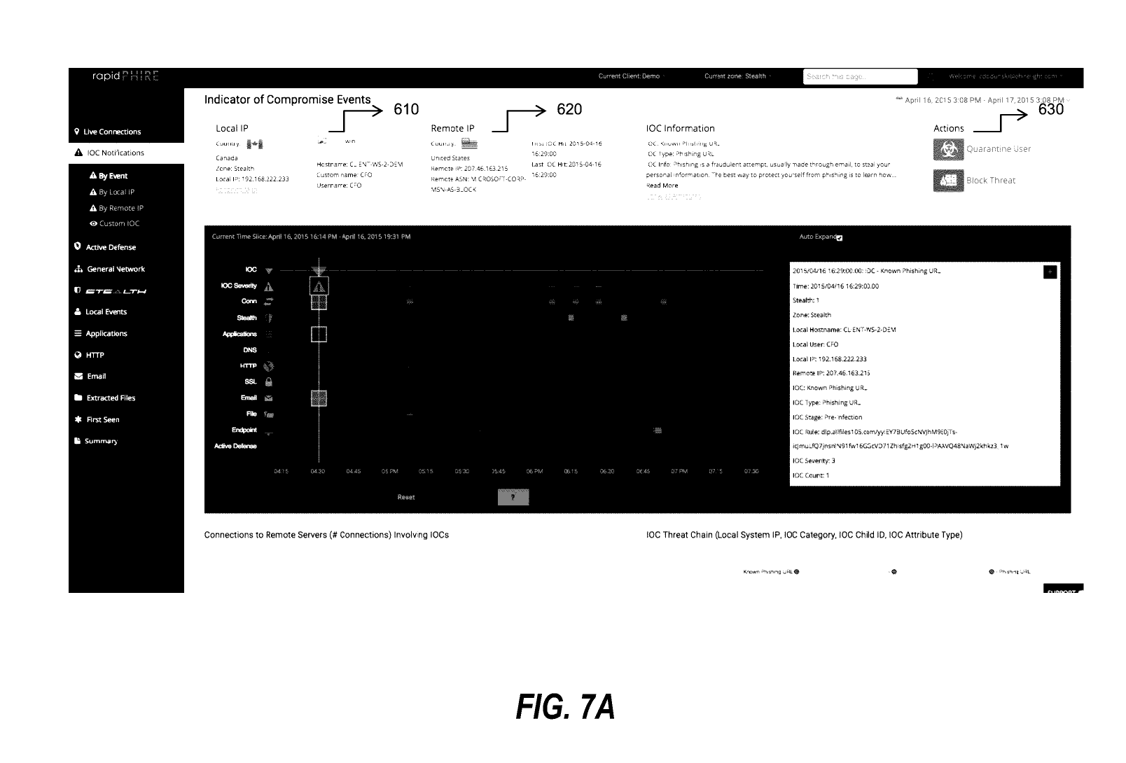

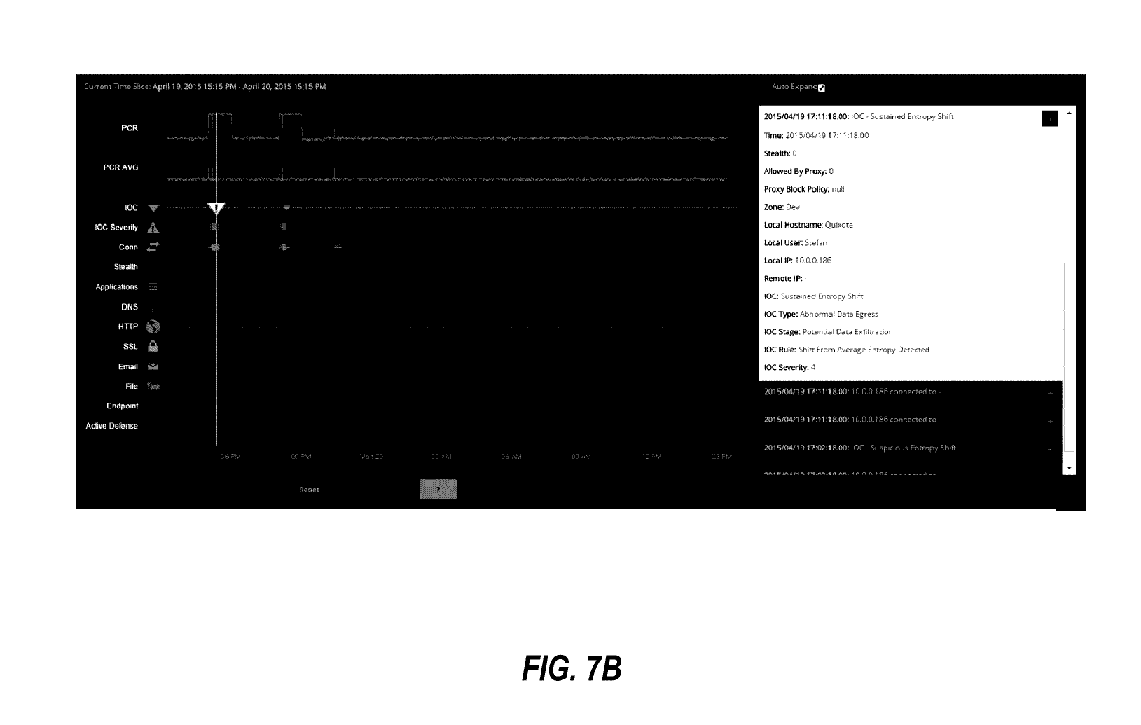

By selecting a specific IOC (for example, by clicking on the specific IOC from within the table in the main dashboard screen of FIG. 6), additional detail on the specific IOC can be obtained. FIG. 7A shows the scenario where the specific IOC is a Known Phishing URL; in this case, the additional detail on the specific IOC may include local IP 610 and remote IP 620 associated with this specific IOC. In addition, actions (e.g. ‘Quarantine User’, ‘Block Threat’) 630 for dealing with the specific IOC may be chosen by the operator from within the dashboard. Thus, automated, fine-grained remediation of cyber threats can be implemented in accordance with embodiments of the present disclosure. Other potential actions may include denying communications, restricting network ports, killing processes, throttling bandwidth, revoking access etc.

The additional detail may also include objects of evidence collected using the system and methods described earlier in this disclosure. An IOC can thus be considered as a parent event that the system of the present disclosure has detected due to threat intelligence or behavioral analysis. Each IOC can be made up of multiple objects (may also be referred to herein as observations) like DNS records, or HTTP sessions. Each object is denoted by a square icon in the swim lanes, and contains multiple attributes.

The various objects fall into different categories abbreviated in FIG. 7A as Conn, Stealth, Applications, DNS, HTTP, SSL, Email, File, Endpoint, and Active Defense, which are denoted by horizontal lines (referred to herein also as ‘swim lanes). As noted earlier, each object of evidence is shown as a square icon on a swim lane of FIG. 7A, and allows for further analysis (e.g. “cyber” kill chain analysis) of the specific IOC. An additional horizontal line may indicate ‘IOC Severity’, and may be an attribute of the reason behind the software alerting you to the IOC in the first place.

With regard to the various categories, the category abbreviated as ‘Conn’ represents all the IP layer information (source, destination, ports, etc.) that is involved if the IOC is connection-based and not behavioral in nature. The category abbreviated as ‘Application’ identifies any applications attributed to the connection or behavior that caused the alert, while the categories abbreviated as ‘HTTP’, ‘DNS’, ‘File’, ‘SSL’, ‘Email’ are all pieces of payload information in the session that was reconstructed by the software and analyzed for threats. The category abbreviated as ‘Endpoint’ represents objects received from an endpoint event logger on the workstation, server or laptop, while the category abbreviated as ‘Active Defense’ is an indication that the software has taken automatic actions to prevent something from happening (e.g. killing an application that is unwanted in the network). Additional categories may include PCR and PCR Average as shown in FIG. 7B. PCR values can be plotted in time and shifts are shown to indicate a shift in role from consumer to producer and vice versa, which may be an indication of breach and/or exfiltration.

Vertically aligned objects are linked by a common time occurrence (as the horizontal axis depicts time) and are either correlated events, pieces of evidence and/or observations logically related to the specific IOC. In embodiments, the objects show all suspicious, malicious or noteworthy events that have been linked to the IOC. In embodiments, the objects show all suspicious, malicious or noteworthy events that have been attributed to the user that has been linked to the IOC. The panel on the right of FIG. 7A is a summary attribute window that is displayed by selecting the object of the category “IOC Severity’. It summarizes the attributes of the events denoted by all of the square icons shown on the swim lane graph for the specific IOC.

The visualization tool allows a network operator to zoom into the data by dragging your mouse horizontally across a swim lane and releasing the mouse button. The ‘Reset’ button of FIG. 7A clears any zoom functions performed; the ‘Previous’ button does an “undo” of the last zoom; while the ‘Next’ button performs a “redo” of a zoom that was done. For example, if a zoom is performed by the network operator, he/she can undo that zoom with the selection of the ‘Previous’ button, and then re-zoom to the original zoom level by selecting the ‘Next’ button. Thus, the ‘Previous’ and ‘Next’ gives a way to zoom back and forth between two settings of zoom.

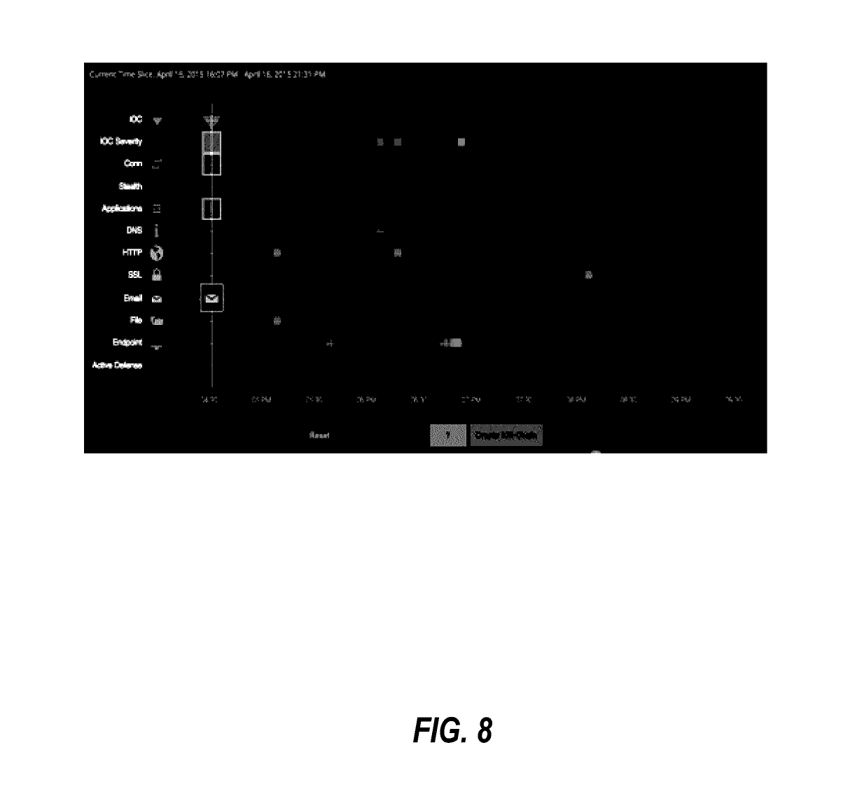

Selection of any specific object on the swim lane graph of FIG. 7A shows details on one or more attributes of the specific event denoted by the specific object selected—see for example, the attribute window at the right in FIG. 8 that is displayed when the ‘Email’ object of the vertical line is selected. The one or more attributes for an ‘Email’ object may include ‘Subject’, and ‘From’ and ‘To’ addresses.

When you are creating a kill chain for analysis, you are constructing a visual query that can span multiple attributes, objects and IOCs. In the end, the kill chain analysis is about the attribute, but these attributes may exist inside other objects and other IOCs. The “Analyze Kill Chain” will find the attributes that match and present the results.

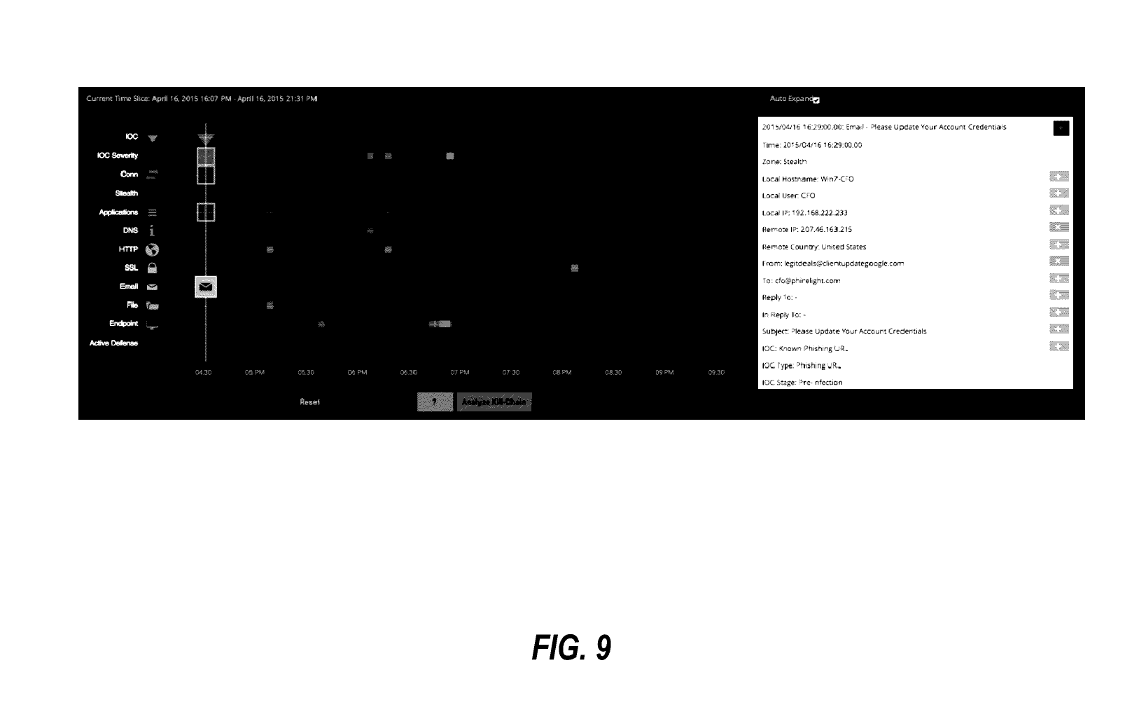

The visualization tool of the present disclosure allows for selection of one or more attributes and/or objects that an operator wishes to perform deeper analysis on—such analysis allows for determination of the impact of the chosen objects on the overall network. For example, the dashboard of FIGS. 6, 7A, 7B has a ‘Create Kill Chain’ button that can be accessed to start a kill chain analysis of a series of objects. Selection of the ‘Create Kill Chain’ option gives the operator the ability to select at least some of the attributes associated with the first object selected for the kill chain analysis. This may be in the form of an array of selectable handles (the handles are denoted with a “+” before selection and with a “x” after selection, in the ‘attribute window’ on the right hand side of FIG. 9). In embodiments, the ‘Create Kill Chain’ option also gets re-labeled to ‘Analyze Kill Chain’ once selected. Alternately, an ‘Analyze Kill Chain’ option may be available via a separate button that may be made accessible only after the ‘Create Kill Chain’ option is selected.

Once the ‘Analyze Kill Chain’ option is selected, a search of the entire database for occurrences of any selected attribute or series of attributes from one or more object containers is conducted.

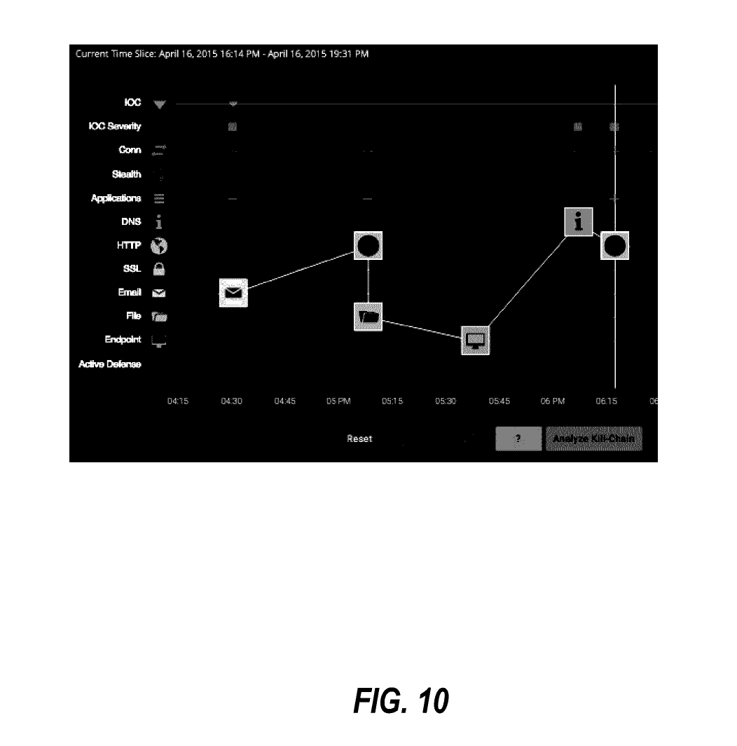

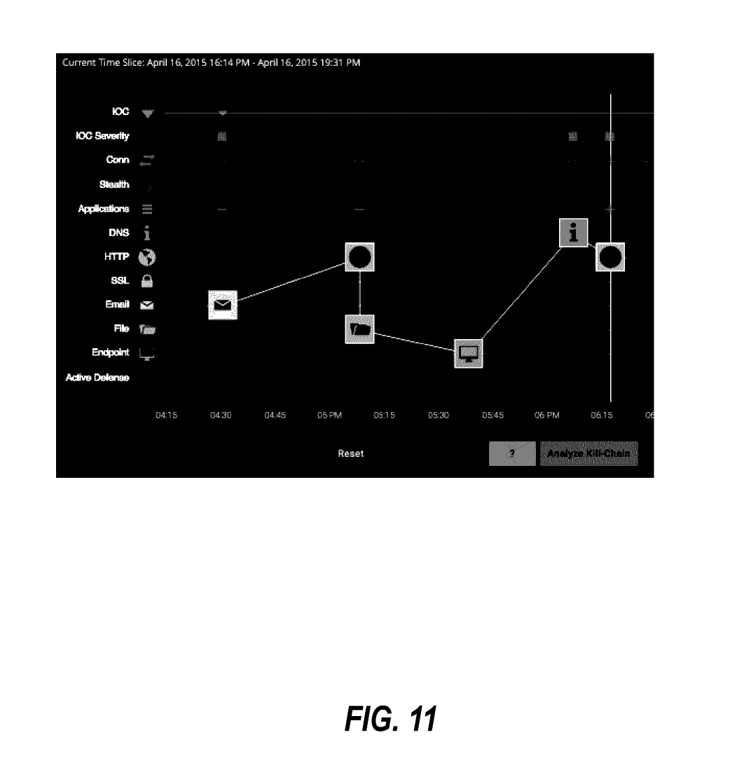

If multiple objects are selected for analysis (i.e., at least one attribute is selected for each of the multiple objects), a line will be drawn between the icons representing these objects as shown in FIGS. 10-11 to visually indicate the objects and associated data sets that are considered for the database query that will be executed when the “Analyze Kill Chain” button is pressed. Thus, the network operator can generate a ‘visual query’ (by simply drawing a line between icons) to analyze complex security data in an intuitive and easy-to-use manner.

Thus, the kill chain line of FIGS. 10-11 provides a visual representation of the query you are constructing when one or more attributes are selected. When two or more attributes are selected, and these attributes belong to different objects, at the line will be drawn between the associated icons to indicate where the attributes exist. Lines can occur between icons associated with objects linked to the same IOC (for example, on a single vertical line) or lines can occur between objects spanning multiple IOCs occurring at different times (i.e. the lines would be horizontal or diagonal).

If only a single attribute is selected during the creation of the kill chain (i.e. the selection of attributes of the kill chain), the database query that is executed will search the entire database for any occurrences of the selected attribute during the creation of the kill chain (i.e. the selection of attributes of the kill chain). If multiple attributes are selected, the query is essentially an “OR” query between all of the selected attributes (i.e., find all instances of Attribute _1 OR Attribute_2 OR Attribute_3 . . . ).

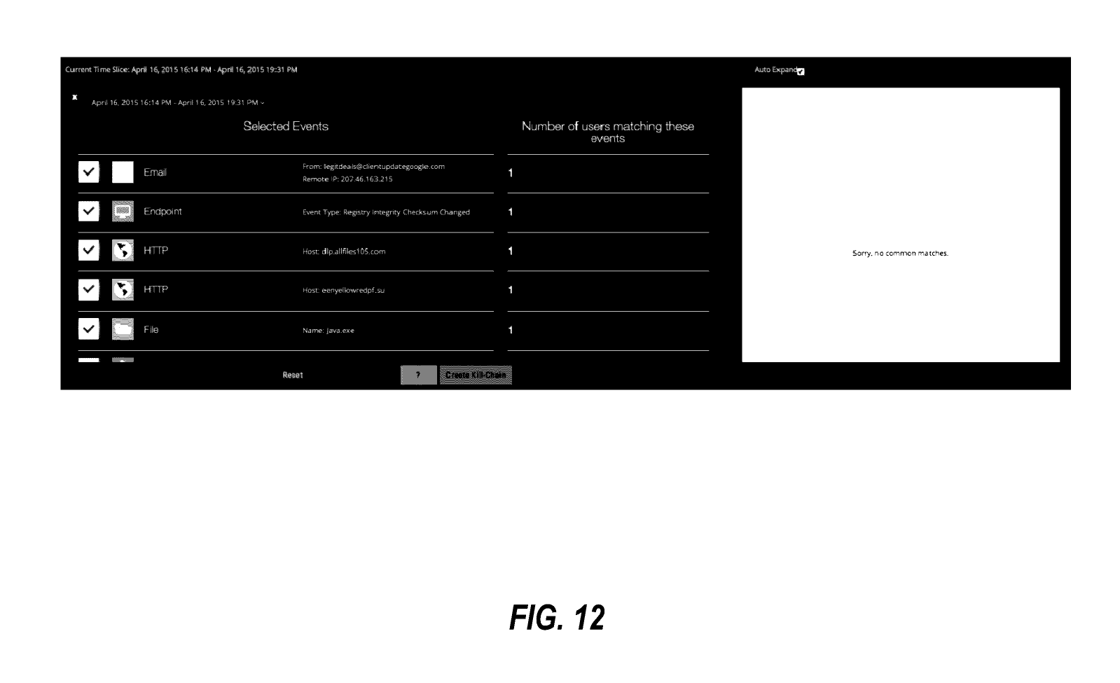

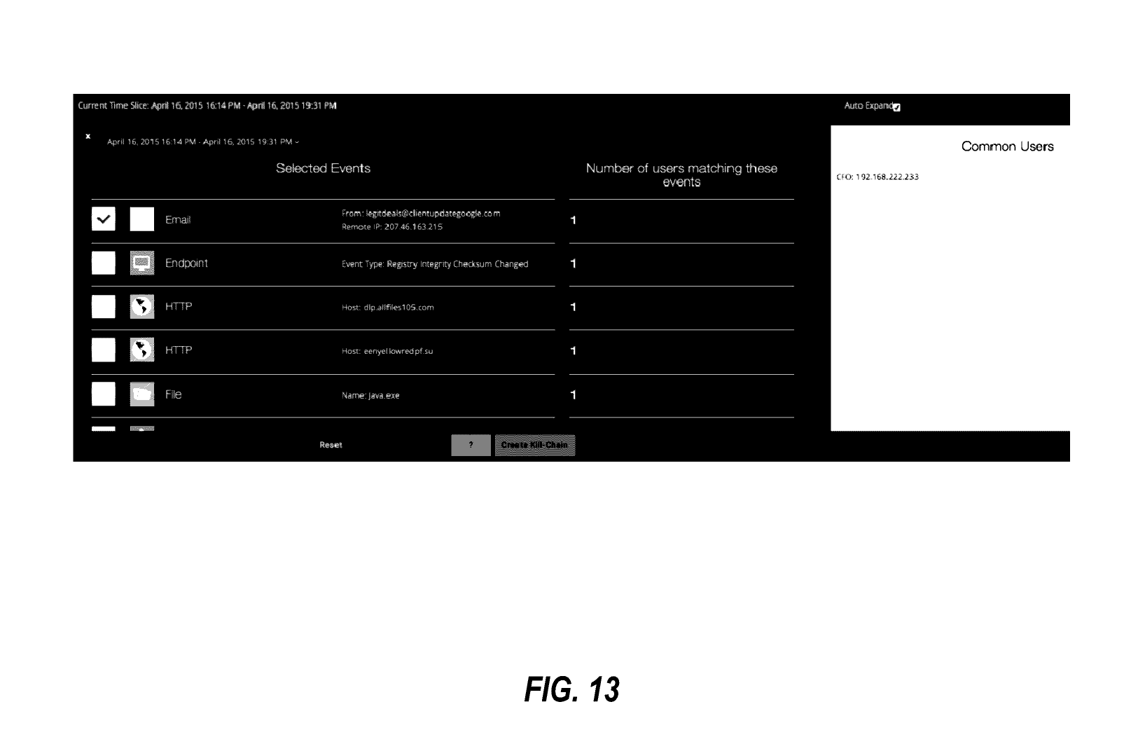

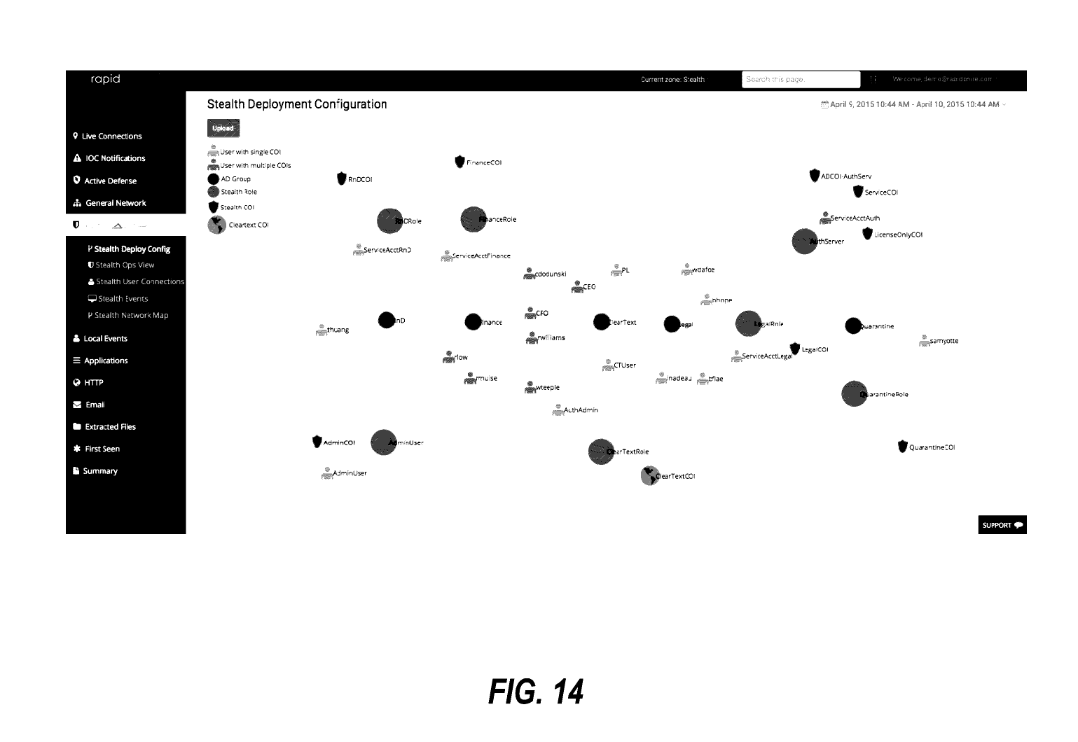

Although the query is ‘OR’-based, for effectiveness of use for the operator accessing the visualization tool, the presentation of the analysis results is primarily ‘AND’ in nature. As such, an information panel on the right side of FIG. 7 displays any results that match the query Attribute 1 AND Attribute 2 AND Attribute 3 However, in embodiments, the result of each individual query is also shown. The column “Number of users matching these events” of FIG. 13 shows the number of users matching each individual query. FIG. 12 shows a scenario where the ‘AND’ result is a null set since none of the attributes have any common results; as such, the information panel on the right displays ‘Sorry, no common matches.’). The tool allows any of the previously selected attributes/objects to be deselected so as to ‘broaden’ the query. FIG. 14 shows the scenario where the previously selected objects (see FIG. 13 for previous selection) of ‘Endpoint’, HTTP, HTTP, File are deselected; results of this ‘broader’ query are shown in the right panel of FIG. 14.

The results of the query may also be an IP address rather than a user. If the system has access to user-level information, the query results are users; however, if the user cannot be identified, the IP address is presented as the results of the query.

In embodiments, these queries are run against the entire database of all data from time=0 through the present. Using this span of time allows kill chain attacks of various time durations to be discovered or otherwise identified through analysis. For example, as all data from time =0 to the present is analyzed, attacks that are implemented as a rapid series of events as well as “low and slow” attacks (a low and slow attack is an attack where the required discrete steps of the attack are done very slowly, e.g. one step per week) can be discovered. Alternately, the queries may be run against a subset of the data stored in the database.

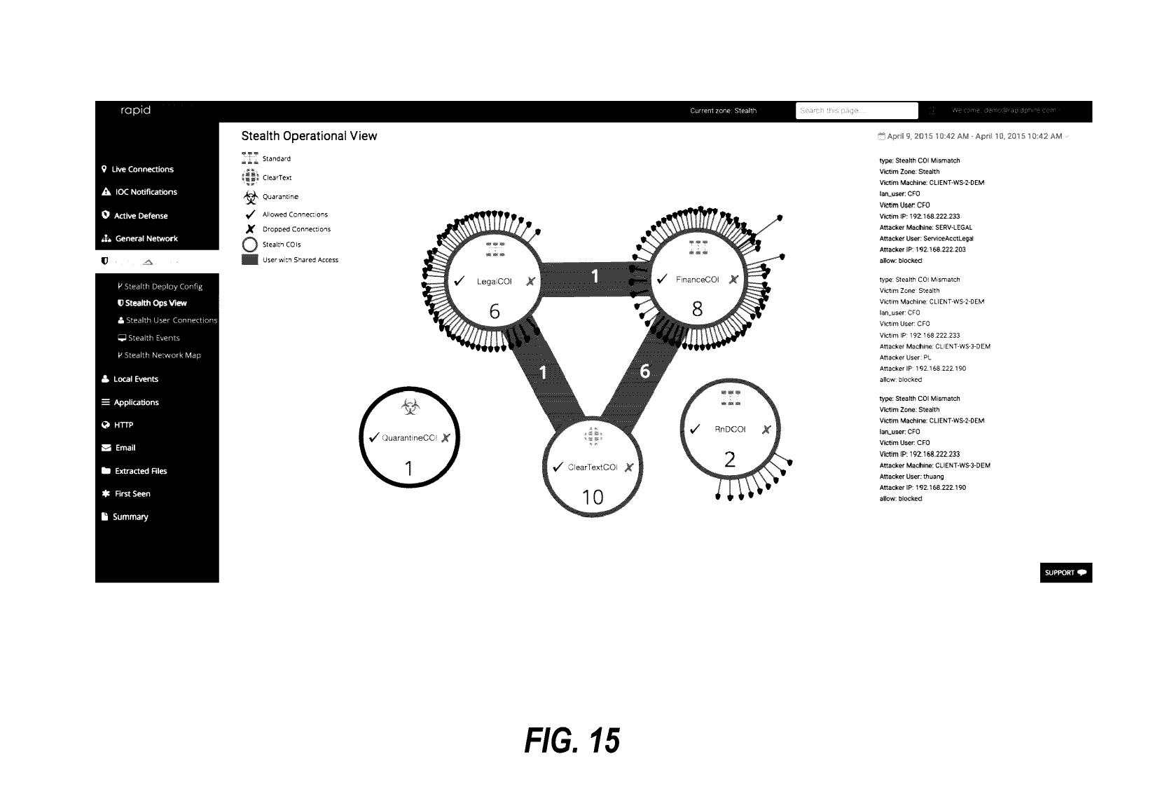

The above-noted visualization capability of the cyber intelligence analytics server 330 may also be used apart from the rest of the system, for example to display deployment configurations using information extracted from identity management systems (e.g. Windows Active Directory (AD)) or other security products (e.g. the configuration file of a Software Defined Networking (SDN) security product such as Unisys Stealth). FIG. 15 shows a visual of an intended Stealth deployment (exemplarily, a Unisys Stealth Deployment Configuration). Such a display allows an operator to see relationships and possible outliers.

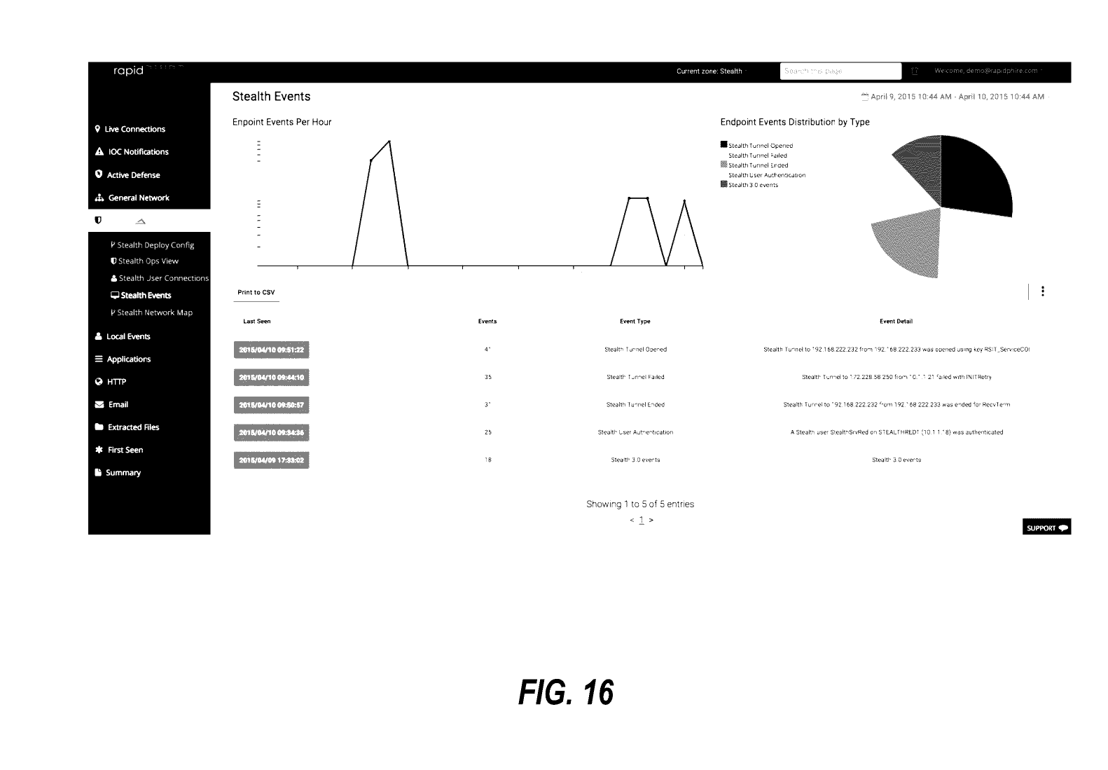

FIG. 16 shows a Stealth operational view, with each Community of Interest (COI) associated with dashboard-style display that can display COI rules, discarded communication attempts, allowed communication attempts and users. A COI represents a group of computers that are only allowed to talk to each other and cannot be seen by anything that is not in the community. Bridges between COIs show users who span multiple COIs. Quarantine COI is pre-established to move any suspected compromised users/systems into isolation. Each red spine surrounding the COI represents an attempted connection made to a Stealth asset that Stealth discards.

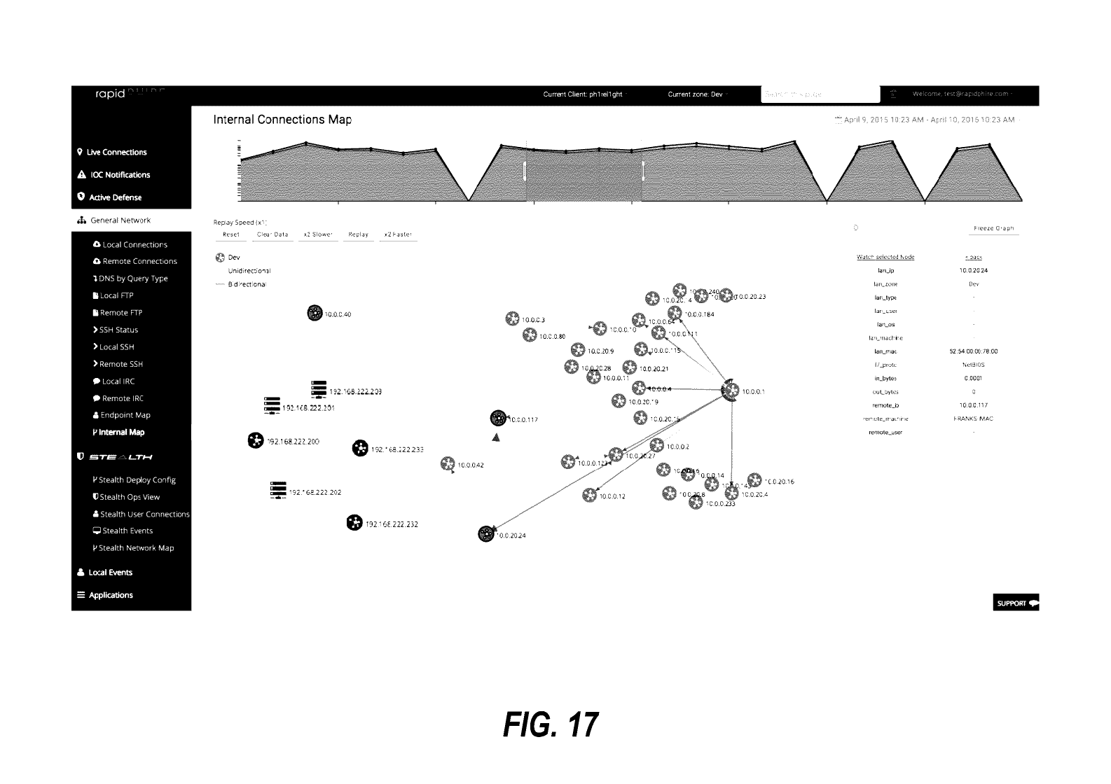

FIG. 17 shows Stealth system events (tunnel open, tunnel closed, user authenticated, etc.) tracked over time.

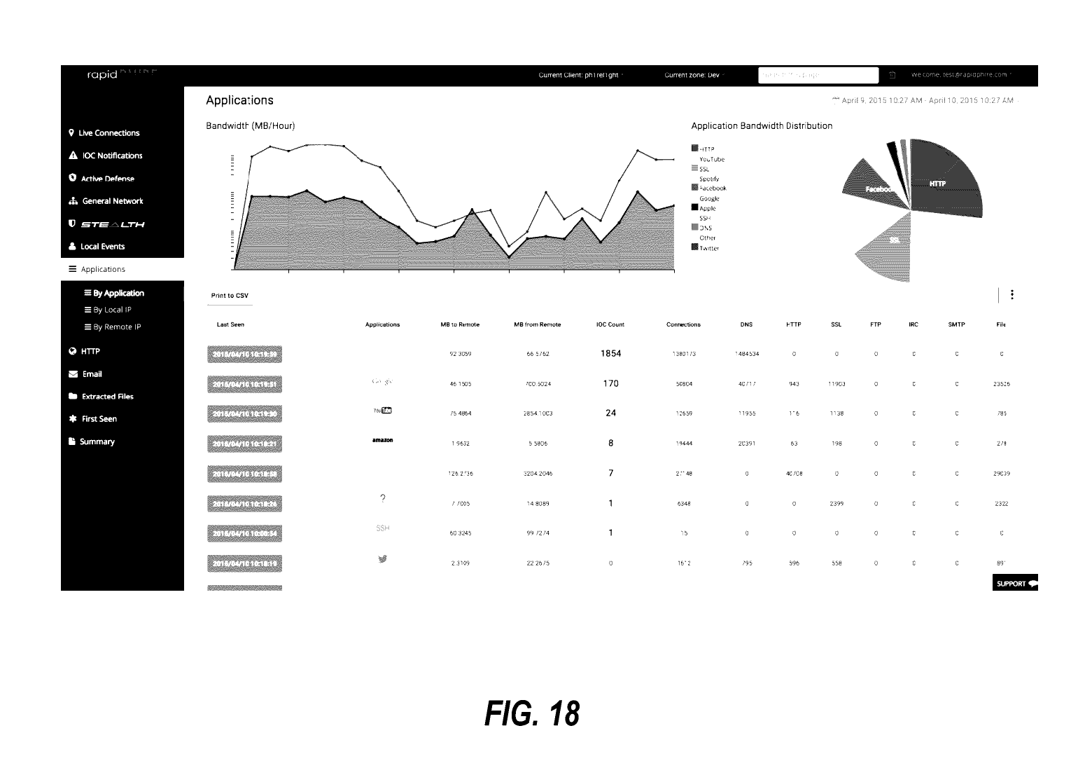

In embodiments, the visualization tool can also represent internal communications between detected systems as shown in FIG. 18. This functionality can be used to determine what traffic is being seen between Stealth enabled endpoints. In addition, users can play back traffic communications to validate what is happening after policies are modified.

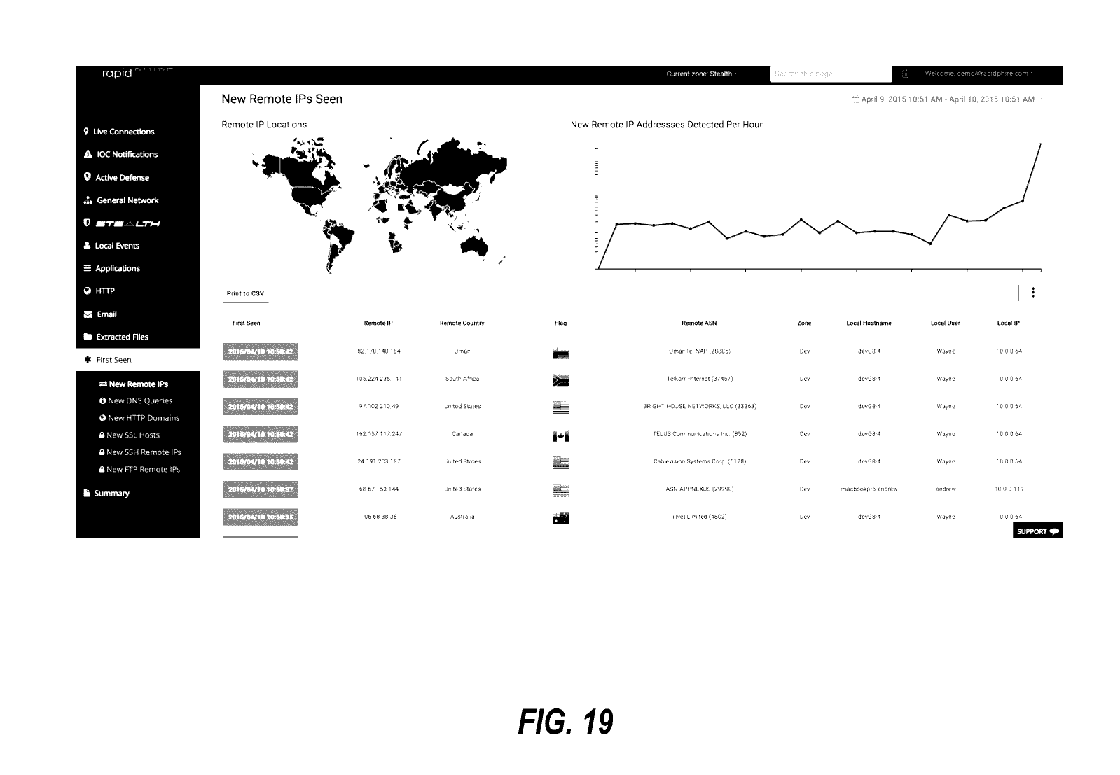

In embodiments, the visualization tool allows users to see what applications are running in the network, who is using them, and if they are involved in Indicators of Compromise (IOCs), as shown in the Application Classification page of FIG. 19.

In embodiments, the visualization tool shows the location and information of any newly discovered IP addresses that have been detected in the past 24 hrs. Other items that may be tracked include DNS queries, HTTP hosts, SSL hosts, SSH connections, FTP servers, and new MAC addresses. While a new IP address is not necessarily malicious, an operator may deem it worthwhile to investigate such new IP addresses further, particularly if new DNS resolver locations are traced to foreign countries.

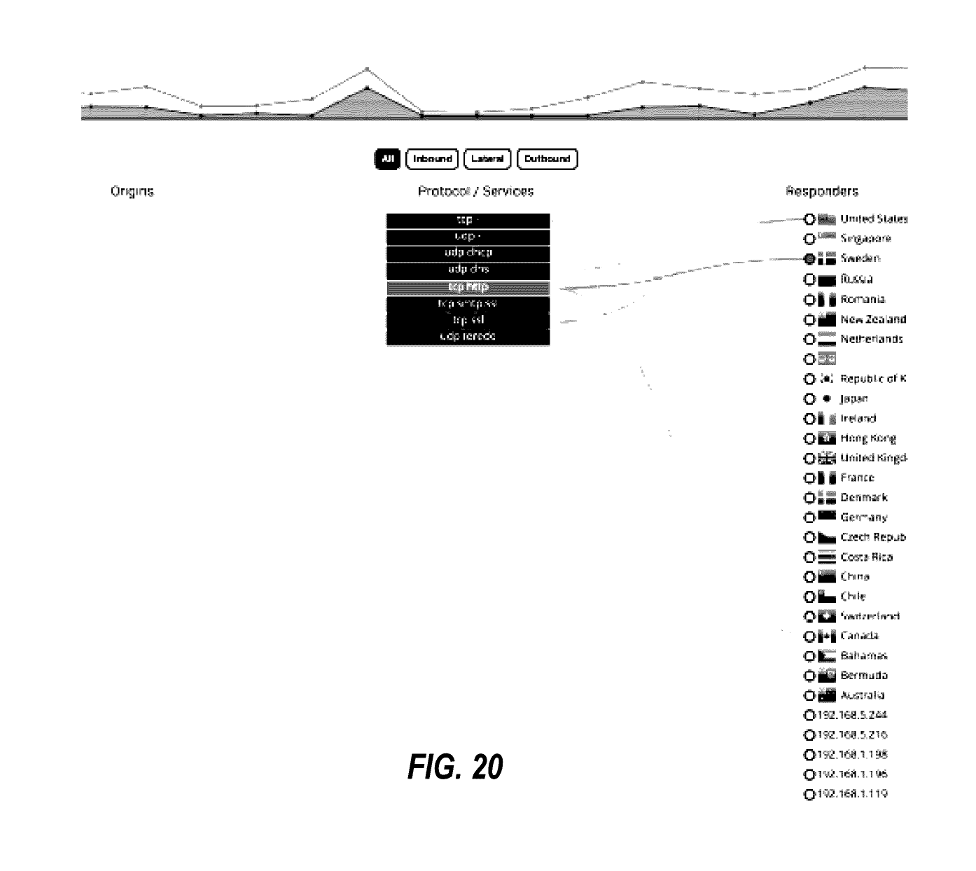

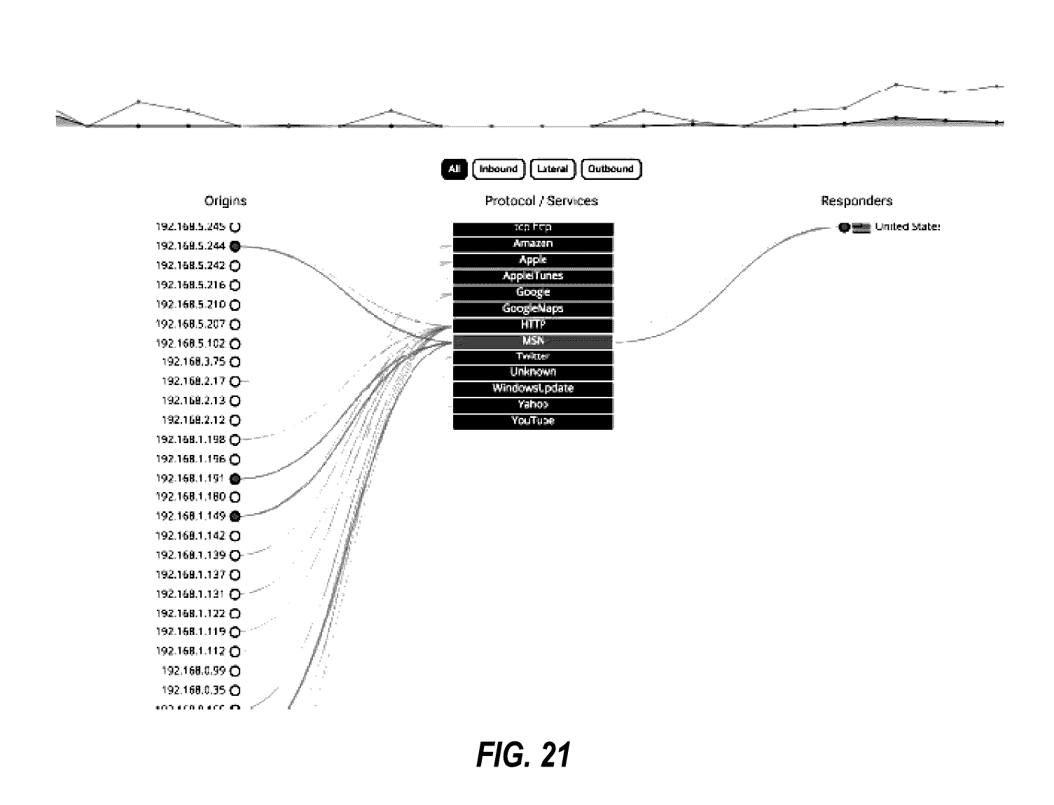

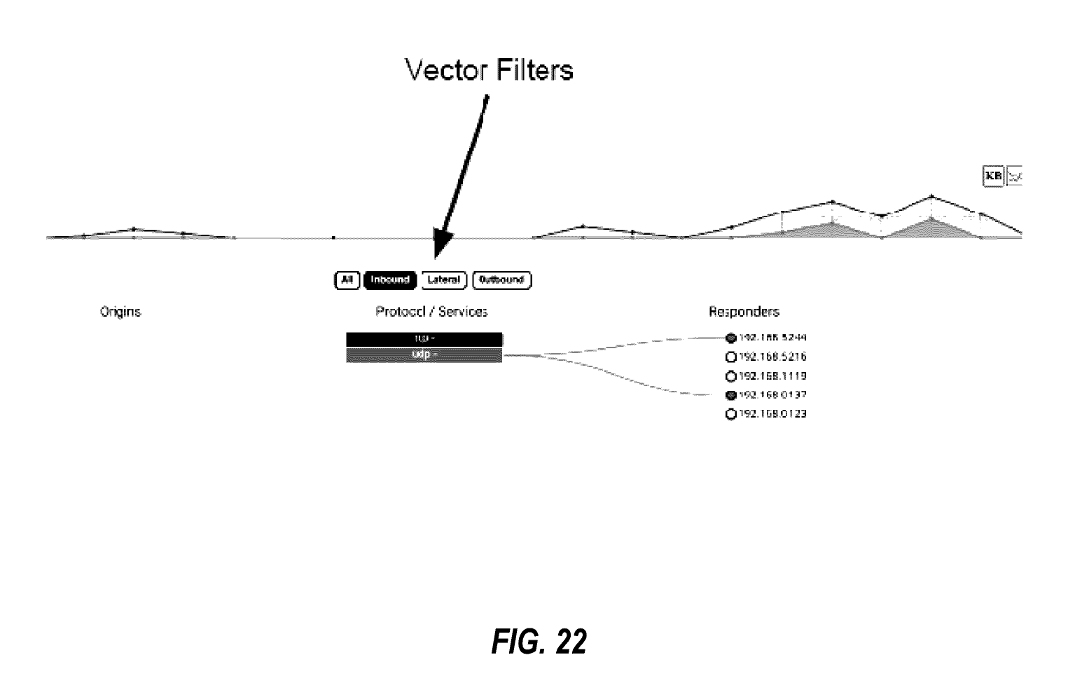

FIGS. 20-22 show screen shots of a services view. In FIG. 20, the Services View provides a breakdown of responding servers (or the countries of their origin) and displays the protocol that they are serving. Colored lines indicate an associated IOC. Clicking on either the Responder or the protocol will present a list of the originators (i.e. client systems) who have been communicating with these Responders (FIG. 21). In FIG. 21, the responder “United States” was clicked. Additionally, the protocol “TCP and HTTP” was also selected. What is presented is a breakdown of all clients (Origins) who connect to the USA hosting these http services. In FIG. 22, there are three vectors of communications in the Services View to display: Inbound (i.e. the local servers responding to external client requests as shown), Lateral (i.e. internal to internal communications), and Outbound (i.e. a remote IP host that is serving data to an internal client).

It will be appreciated that some exemplary embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the exemplary embodiments described herein, a corresponding device such as hardware, software, firmware, and a combination thereof can be referred to as “circuitry configured or adapted to,” “logic configured or adapted to,” etc. perform a set of operations, steps, methods, processes, algorithms, functions, techniques, etc. as described herein for the various exemplary embodiments.

Moreover, some exemplary embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various exemplary embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A network traffic analysis method for tracking, analyzing, and mitigating security threats in a network, the network traffic analysis method comprising:
receiving information based on monitoring traffic at a plurality of layers at one or more monitors deployed in the network utilizing deep packet inspection;
receiving information based on monitoring the traffic at an endpoint of the network;
analyzing the monitored traffic from the endpoint and the one or more monitors to determine network infrastructure and cyber security posture of the network infrastructure; and
providing visualizations based on the network infrastructure and the cyber security posture, continuously to track threats, watch lateral movement in the network of the traffic, and determine security event history in the network.

2. The network traffic analysis method of claim 1, wherein the visualizations comprise a cyber kill chain analysis comprising a visual query of the network spanning multiple attributes, objects, and indicators of compromise (IOCs) representing analyzed monitored traffic determined as important to security and indicative of a compromise or breach of the network.

3. The network traffic analysis method of claim 1, wherein the visualizations comprise Producer-Consumer Ratio (PCR) entropy scores for various nodes in the network, the PCR entropy scores track a ratio of producer to consumer data as a normalized index independent of data rate to provide an overall directionality of flow relative to a particular network node, and the network traffic analysis method further comprising:
utilizing the PCR entropy scores to provide early detection of data exfiltration.

4. The network traffic analysis method of claim 3, wherein the PCR entropy scores are derived from Netflow information based on the monitoring the traffic.

5. The network traffic analysis method of claim 1, wherein the one or more monitors comprise one or more agents integrated into any of shared servers, Structured Query Language (SQL) servers, and mail servers to provide the information related to audit logs and event types.

6. The network traffic analysis method of claim 1, wherein the one or more monitors are deployed in selected areas of the network where deep packet analysis is needed, in various zones throughout the network.

7. The network traffic analysis method of claim 1, wherein the monitoring the traffic comprises utilization of Netflow, Data Fusion, and Deep Packet Inspection.

8. The network traffic analysis method of claim 1, wherein the one or more monitors comprise sensors plugged into a router port in the network.

9. The network traffic analysis method of claim 1, further comprising:
performing an active defense in the network based on the visualizations to one or more of quarantine, deny communication, restrict network ports, kill processes, throttle bandwidth, and revoke access.

10. A network traffic analysis platform system for tracking, analyzing, and mitigating security threats in a network, the network traffic analysis platform system comprising:
at least one sensor deployed in the network adapted to monitor traffic at a plurality of layers utilizing deep packet inspection;
a monitor deployed at an endpoint in the network adapted to monitor traffic; and
an analytics server communicatively coupled to the at least one sensor and the monitor, wherein the server is configured to
receive information based on the monitored traffic,
analyze the information to determine network infrastructure and cyber security posture of the network infrastructure, and
provide visualizations based on the network infrastructure and the cyber security posture, continuously to track threats, watch lateral movement in the network of the traffic, and determine security event history in the network.

11. The network traffic analysis platform system of claim 10, wherein the visualizations comprise a cyber kill chain analysis comprising a visual query of the network spanning multiple attributes, objects, and indicators of compromise (IOCs) representing analyzed monitored traffic determined as important to security and indicative of a compromise or breach of the network.

12. The network traffic analysis platform system of claim 10, wherein the visualizations comprise Producer-Consumer Ratio (PCR) entropy scores for various nodes in the network, the PCR entropy scores track a ratio of producer to consumer data as a normalized index independent of data rate to provide an overall directionality of flow relative to a particular network node, and wherein the server is further configured to:
utilize the PCR entropy scores to provide early detection of data exfiltration.

13. The network traffic analysis platform system of claim 12, wherein the PCR entropy scores are derived from Nedlow information based on the monitoring the traffic.

14. The network traffic analysis platform system of claim 10, wherein the one or more monitors comprise one or more agents integrated into any of shared servers, Structured Query Language (SQL) servers, and mail servers to provide the information related to audit logs and event types.

15. The network traffic analysis platform system of claim 10, wherein the one or more monitors are deployed in selected areas of the network where deep packet analysis is needed, in various zones throughout the network.

16. The network traffic analysis platform system of claim 10, wherein the monitoring the traffic comprises utilization of Netflow, Data Fusion, and Deep Packet Inspection.

17. The network traffic analysis platform system of claim 10, wherein the one or more monitors comprise sensors plugged into a router port in the network.

18. The network traffic analysis platform system of claim 10, wherein the server is further configured to
perform an active defense in the network based on the visualizations to one or more of quarantine, deny communication, restrict network ports, kill processes, throttle bandwidth, and revoke access.

19. An apparatus for tracking, analyzing, and mitigating security threats in a network, the apparatus comprising:
a network interface communicatively coupled to the network;
a processor communicatively coupled to the network interface; and
memory storing instructions that, when executed, cause the processor to receive information based on monitoring traffic at a plurality of layers at one or
more monitors deployed in the network utilizing deep packet inspection, receive information based on monitoring the traffic at an endpoint of the network, analyze the monitored traffic from the endpoint and the one or more monitors to determine network infrastructure and cyber security posture of the network infrastructure, and
provide visualizations based on the network infrastructure and the cyber security posture, continuously to track threats, watch lateral movement in the network of the traffic, and determine security event history in the network

20. The apparatus of claim 19, wherein the visualizations comprise a cyber kill chain analysis comprising a visual query of the network spanning multiple attributes, objects, and indicators of compromise (IOCs) representing analyzed monitored traffic determined as important to security and indicative of a compromise or breach of the network.
